(19) United States
(12) Patent Application Publication
(10) Pub. No.: US 2026/0287081 A1
(43) Pub. Date: Sep. 24, 2026

(54) IMPROVEMENTS IN, OR RELATING TO VALVES AND METHODS THEREFOR

(71) Applicants: Ian Craig PATERSON, Ponsonby (NA); Paolo CORSINI, London (GB); Globalforce IP Limited, Auckland (NZ)

(72) Inventors: Ian Craig PATERSON, Auckland (NZ); Paolo CORSINI, London (GB)

(21) Appl. No.: 19/119,617

(22) PCT Filed: Oct. 12, 2023
(86) PCT No.: PCT/IB2023/060270

§ 371 Date: Apr. 9, 2025

(30) Foreign Application Priority Data
Oct. 12, 2022 (NZ) 793273

(51) Int. Cl. F16K 27/04; F16K 3/26; F16K 31/122; F16K 41/04

(52) U.S. Cl. CPC F16K 31/1221; F16K 1/123; F16K 1/126; F16K 3/24; F16K 3/265; F16K 15/026; F16K 27/0254; F16K 41/04; F16K 31/04; F16K 31/06; F16K 31/523; F16K 31/52475; F16K 2200/502

(57) ABSTRACT

Disclosed are methods and apparatus for valve to control flow of a fluid under pressure. The has a valve body with a first port, and a second port. A valve bonnet engages to the valve body. A valve member has an endless skirt supported by a central spindle within valve body from the valve bonnet, and an outer periphery, and has a closed position to prevent flow of fluid, and an open position to allow flow of fluid. The endless skirt, when in the closed position, sealing against the valve bonnet at a first sealing diameter (D1), the endless skirt in sliding and sealing engagement at, and between, the open position and the closed position, with an interior periphery of the annular chamber at a second sealing diameter (D2), a first pressure area defined between D1 and D2, providing a bias toward the closed position. The endless skirt when in the open position allows fluid to flow between the first port, via an interior diameter of the endless skirt, and the second port. The central spindle in sliding and sealing engagement with the valve bonnet at a third sealing diameter (D3), defining a second pressure area, which on receipt of fluid provides a bias closed.

### TECHNICAL FIELD OF THE INVENTION

The present invention relates to valves, and methods therefor.

In particular, though not solely, the present invention is directed to valves that are referred to as linear acting valves, globe valves, and balanced globe valves.

### BACKGROUND OF THE INVENTION

Each valve has its own advantages and disadvantages which are either up or down-weighted during the valve selection process for each specific use case (industry, media, conditions, and specific piping system requirement). When the task the valve must compete is not highly challenging and the valve simply needs to be ‘good enough’, then the primary selection criteria between valve types will be cost, technician familiarity, or simply preference.

It's important to address that the world of valves is extremely well progressed, valve technology has been advancing since the industrial revolution. An example of that change is that globe valves used to represent a much larger proportion of the valve market, but have slowly lost market share, particularly in isolation tasks as more and more valve options have entered the market. A good example was the invention of the ball valve by Crane in the 1940s. Ball valves now represent a significant share of the market in a hugely diverse range of industries, working fluids, sizes, and are paired with several actuation technologies to control them.

Another important characteristic of valves is that they are never ‘the point’ of a system, and apart from some small domestic use cases, a valve is very infrequently a retail item. The vast majority of valves are sold by companies via distributers, sometimes via an intermediate contractor, to users who then use those valves as part of a system to make some other end product or to deliver some service. If two valves are able to do the same ‘good enough’ job to enable whatever the value creation task is, then the remaining value proposition differentiator between valve products/types is generally purchase cost, or total cost of ownership.

Apart from cost, the remaining purchasing considerations a buyer will consider are reliability, uptime, weight, size, compliance with standards, response speed and behaviour and more. But generally, it is largely fair to claim that the vast majority of flow control use cases currently have a valve technology available which is at least serviceable—but it is also fair to say that many flow control tasks use valves which have a significant cost associated with the valve and actuator assembly which many users would identify as a problem.

Ball valves, so named as their flow control element is shaped like a ball, are often used for hygienic use cases due to having good sealing properties and having simple operation. However, they also inherently contain cavities (between the ball and valve body) which can be difficult to flush. Some hygienic ball valves have additional ports added to the body to clean these cavities—which adds cost and complexity to the assembly and manufacture. High actuation torque requirements combined with the need to manufacture a very smooth spherical body can also drive significant cost, particularly in large sizes.

A globe valve (unlike most other valves) is named as such due to the globular shape of the valve body. Most other valves are named with reference to the geometry of their flow control element (also known as an obturator). A globe valve has a movable plug element that engages with a valve seat of either a hard or soft (also known as resilient) material. The globe valve normally has a body with at least one inlet and at least one outlet, between which is the plug element and valve seat to start, stop and regulate the flow between the inlet(s) and outlet(s). The plug element is normally attached to a spindle which moves relative to a valve bonnet that engages to the valve body and seals it off. Typically, the valve body is sealed about the spindle by a stuffing box. The spindle, and hence the plug element, is moved on and off the valve seat normally by the spindle engaging with a threaded interface to the bonnet—rotation of the spindle moves the spindle and hence the plug element up and down to open or close the valve, or vice versa. The rotation of the spindle may be by hand, e.g., using a wheel, or by a mechanical actuation means, e.g., a stepper motor or similar, to rotate the spindle and hence locate the plug element relative to the valve seat as needed for the control of flow desired. Direct linear actuation methods can also be used which do not include a threaded interface between the bonnet and spindle—resulting in solely linear motion rather than helical motion of the spindle.

Such valves may have the inlet(s) in line with the outlet(s), or at an angle to each other, and may be used for gasses, fluids, slurries, multiphase fluids or similar—collectively we will use the term fluid, but this may mean any form of flow that requires stopping, starting, or regulating through the valve.

A disadvantage of such globe valves is that high spindle forces can be required to create a reliable leak free seal. Any valve seating method needs to create sufficient force between the flow control element and the valve seat to exceed the pressure of the flow it is controlling. Unbalanced globe valves (and therefore actuation systems) must additionally overcome the force generated by any differential pressure across the valve. Therefore, for a valve to control a high-pressure fluid the clamping force requirement of the flow control element to the valve seat (valve seat seal pressure) must be very high. Also, the pressure required to seal the spindle via the stuffing box (spindle seal pressure) must also be very high, adding to the friction of the system, further increasing actuation force. These singularly, or in combination, result in a valve that is stiff to operate, must have seats and seals which are designed to absorb high actuation forces, and can have high wear, or require special materials and frequent maintenance.

A balanced piston/cage guided globe valve, often referred to as flow modulating control valves (so called as the overall workings are similar to a globe with the flow control element moving within the valve body to stop/start and regulate flow within a windowed cylinder, called a cage), use pressure balancing to significantly reduce the actuation force required to actuate the valve. The pressure associated with the process fluid does not have any large pressure areas to act against in the direction of actuation, meaning that precise control can be achieved without the need for large and powerful actuation or for the seat/seal to sustain such high loads or valve seat seal pressures. These control valves use a cage which is housed between the valve bonnet and body to retain the seat and guide the flow control element. The use of the cage as the guiding element means the internal surface of the cage must be machined to closely match the piston diameter, and therefore drives significant cost for these control valves and makes them incompatible with many use cases simply from a cost perspective. Simply eliminating the cage or using a cage which is not precisely machined is not a real option for these valves as the piston needs to be guided through its movement, or a heavy and stiff stem with significant guidance must be used, or there would no longer be a means of creating a pressure balanced action

By rotating the balanced piston globe valve spindle direction to be on-axis with the flow in a straight-through valve an ‘axial flow’ valve is created. The most common design for this is the design pioneered by Mokveld. These valves exhibit several benefits in packaging size and flow capacity over ‘Z’ body style balanced piston control valves—but have the significant drawback of requiring a complex and expensive to produce internal gearbox or hydraulic system (in the case of the Oxford flow design) to control the flow control element's movement.

Butterfly (Including double-, triple-, quad-, or V-offset) valves include a rotating disk which seals against a resilient seat (generally in the case of 0-, single-, or double-offset valves), or a hard seat (generally in the case of triple-, quad-, or V-offset valves) when the face of the disc faces the axis of flow. Butterfly valves have been displacing ball valves in several applications in recent decades due to their lower material costs (especially at larger sizes) but have the significant drawback of having poor flow capacity, especially where thicker discs are used in higher pressure applications. The seating torque of these valves can be significant, and when in a partially open state the flow control element can experience high hydrodynamic forces—meaning that while smaller actuators are generally usable for butterfly valves than for ball valves, the actuation forces in some applications are still relatively high.

A further disadvantage these valve types is their size, especially when actuated valves are considered. Ball valves and Butterfly valves in many applications require actuators that are frequently much larger than the valve itself, and for pneumatic operation generally require integrated gearboxes (generally rack and pinion or scotch yolk) to transfer linear motion into rotary action which add to the cost of the total system. Actuated globe valve assemblies are very tall compared to the valve size. In addition to material usage, weight, packaging, and transport for such a size, the equipment or system which the valve assembly is installed into must have room for such size, physical support for its mass, and additional clearance around the valve assembly for maintenance and disassembly.

In time or process critical installations, or large valves, it is often not efficient or desirable to unbolt the valve from the flow conduits, e.g., pipes, to which it is attached. Rather the bonnet may be removed and the flow control element, stuffing box, valve body and actuator are serviced as needed, reassembled, and then loaded back into the valve body. Therefore, the space around the valve assembly to allow access and disassembly and assembly for such a “tall” component is a clear disadvantage. If a valve is to be removed from pipework, this requires further space around the valve (the space either designed into the system, or “made” at the time of removal by moving/removing other neighbouring components) to provide a path for removal of the valve. Such valves can be heavy and unwieldy. Replacement with a full new valve off the shelf (or purchased in) is expensive and can be time consuming as the process the valve controls must be interrupted until the replacement valve is installed.

For axial valves, ball valves, and triple offset valves unless an additional flanged port (or equivalent port access, e.g. threaded port) is designed into the valve body, the valves can be impossible to service without removal from the process pipework. In some applications this is a significant issue which results in increased service duration and downtime. The addition of a ‘top entry’ flange to solve this issue can add significant cost to the manufacturing cost of the valve.

Such servicing and maintenance require a specialist knowledge in how to disassemble the subassembly of valve bonnet, spindle, stuffing box, cage and flow control element, replenish or repair them, reassemble them, and then reinstall them. Each step in between disassembly and reassembly requires further time and is an opportunity for an error or contamination. At best this may compromise valve function, at worst it may result in failure of the system the valve is connected to, or in.

The known architectures to date of globe type valves have numerous changes in flow direction from inlet(s) to outlet(s) across the flow control element. Often the change in flow direction is across a sharp edge that results in pressure drop, wear, cavitation and turbulence. Wear and cavitation will shorten the intervals between maintenance and inspection. Alleviation of pressure drop and turbulence may be achieved by using a valve with a larger flow path, but this comes at the expense of a large valve, and hence amplifies the issues noted above.

Further the valves of the prior art are manufactured and assembled for a specific application, or are overengineered and not focussed to provide a focussed and efficient valve. Either way, the assembled valves must be kept in stock, or made to order, for each and every application, and thus have a cost in inventory and storage space.

The valves known to date cannot be customised on demand to an application to provide a compact and efficient valve solution, e.g., by changing the flow control element, valve body, or actuator simply and effectively to provide a valve that is easily and quickly configurable.

Globe valves when installed often will handle materials that are dangerous if they leak, and it is desirable to detect such a leak. It is also useful from a maintenance perspective to know if there is a leak also, whether the material the valve handles is dangerous or not. Therefore it would be desirable to be able to detect leaks within such a valve at least at one or more seals, or the major seal boundaries.

The actuators in valves may have to operate very rapidly, and so there is an advantage and desire if there is the ability to prevent build-up of gas or material that would otherwise prevent actuation, such as by compression of such gases or similar.

Valves will often handle material that is dangerous, or that can present issues, for example if left in place for a long time. For example valve that handle food cannot be left uncleaned for health reasons. Valves that handle materials with particulates or similar also need regular cleaning. The most efficient and cost effective way to achieve this is by Clean In Place (CIP) methods where the pipe work or valve line is flushed to remove any remnants and clean the valve and connected pipes and lines. In situations where crevices or similar may be present material may build up, for example between a valve and the valve body, and the material may not be removed by standard CIP techniques. This presents a risk and may require period inspection and teardown to insure there is no risk, which costs time and money.

Actuators for globe valves come in various forms depending on the force the actuator is required to deliver, the material the valve is controlling and the control architecture in place or chosen to drive the actuator. The valve actuator may also need different methods to attach it to the valve body.

The materials chosen for the valve body, actuator and components, and valve member may be made from differing material. Depending on the process or pressure that is being controlled there may be a need to have different sealing of the valve member. There may be a use to have variations in the material behaviours at the sealing interface of the valve member and valve actuator or part thereof.

It can be desirable to ensure the material and process being controlled has a smooth and attached, low turbulent flow as possible through the valve. In this way there is the least drag, cavitation (and resultant damage) and the valve can be made efficient—ie as small as possible for the given flow rate, pressure and material handled.

In this specification where reference has been made to patent specifications, other external documents, or other sources of information, this is generally for the purpose of providing a context for discussing the features of the invention. Unless specifically stated otherwise, reference to such external documents is not to be construed as an admission that such documents, or such sources of information, in any jurisdiction, are prior art, or form part of the common general knowledge in the art.

It is an object of the present invention to provide an improved valve, with improved flow efficiency for a given size, improved ability to maintain, smaller size for a given application, or increased ease to adapt a valve for a given installation, provide improved valve safety including leak detection and ease of operation, ease and confidence in cleaning of valves, provide ease of attachment of actators and valve bonnets to globe valves, improve or provide variety in sealing interfaces for globe valves, or to overcome the above shortcomings or address the above desiderata, or to at least provide the public with a useful choice.

### BRIEF DESCRIPTION OF THE INVENTION

In a first aspect the present invention consists in a valve (1) to control flow of a fluid under pressure, comprising,
A valve body (2) with a first port (3), and a second port (4), to, in part, define a duct (25) therebetween, to duct the flow of the fluid between the first port and the second port,
A valve bonnet (5) removably engaged to the valve body (2) between the first port and the second port, to further define the duct,
A valve member (6) having an endless skirt (7) supported by a central spindle (8) within the duct from the valve bonnet (5), the endless skirt (7) having an outer periphery, which the valve body (2) defines an annular chamber (38) about, and the endless skirt (7) having an inner periphery (9) which defines an inner chamber (42), the valve member (6) having a closed position to prevent flow of fluid, and an open position to allow flow of fluid,
The endless skirt (7), when in the closed position, sealing against the valve bonnet at a first sealing diameter (D1), the endless skirt in sliding and sealing engagement at, and between, the open position and the closed position, with an interior periphery of the annular chamber at a second sealing diameter (D2), the first sealing diameter (D1) greater than the second sealing diameter (D2), a first pressure area defined between the first sealing diameter and the second sealing diameter, the first pressure area on receipt of fluid under pressure providing a bias toward the closed position,
The endless skirt when in the open position defining an opening between the valve bonnet and endless skirt to allow fluid flow between the first port, via the opening and an interior diameter of the endless skirt, and the second port,
the central spindle in sliding and sealing engagement with the valve bonnet at a third sealing diameter (D3), less than the second sealing diameter, the third sealing diameter (D3) defining a second pressure area, the second pressure area on receipt of fluid under pressure providing a bias toward the closed position,
such that a valve is provided that is biased towards the closed position when in either the open position or closed position.

Preferably the second pressure area is larger than the first pressure area

Preferably the valve body has a valve bonnet aperture (41) to which the valve bonnet is operatively connected to seal the duct, other than the first port and second port.

Preferably the valve bonnet contains or holds an actuator for the central spindle to move the valve member between the open position and closed position.

Preferably the actuator may be actuated by any one or more of the following, gas, fluid, magnetic, mechanical or electrical.

Preferably the actuator, or part thereof, is held or contained within the valve body by the valve bonnet and extends at least in part into the duct.

Preferably the actuator is integral with the bonnet and valve member.

Preferably the actuator, valve bonnet and valve member are a unitary subassembly that is removable from the valve body.

Preferably, the valve member and sealing elements alone separate the inlet and outlet volumes.

Preferably the endless skirt extends in an axis parallel to a main axis of the central spindle and actuator.

Preferably the endless skirt is of constant cross section, at least on that part in sliding and sealing engagement with the interior periphery of the cavity.

Preferably there is a flow conditioner, as an extension into the duct, through which the spindle extends, from the actuator or valve bonnet.

Preferably the flow conditioner provides a tangential edge between the valve bonnet, or actuator, and the spindle.

Preferably there is an aperture in the flow conditioner through which the spindle extends.

Preferably there is a spindle seal in the aperture to slidingly seal the spindle.

Preferably the spindle seal is biased to seal by the pressure of the fluid.

Preferably, the position at which the spindle seal acts on the spindle is at least partially encircled by the duct.

Preferably the flow conditioner can be chosen based on the fluid type, for example dependant on viscosity, phase, inclusions, and the desired effect thereon, e.g. to keep the flow laminar, turbulent, remove or add cavitation, improve mixing or similar.

Preferably the flow conditioner aids in directing the fluid flow through the endless skirt and keeps the flow attached.

Preferably the flow path through the valve body between the first port and second port is constant cross section, or flow area.

Preferably when the valve member is an open position there is a continuous curvature provided by the tangential edges between the valve body and the upper most and lower most edges of the endless skirt, and the valve bonnet, via the flow conditioner, and the spindle.

Preferably there is a flow splitter adjacent to the valve member, and this may be upstream of the valve member or downstream of the valve member depending on the flow orientation through the valve.

Preferably the duct between the first port and the second port has a continuous curvature with no sharp edges, save for the flow splitter if present.

Preferably the flow splitter splits the flow vertically, or horizontally or both.

Preferably the flow splitter directs the flow to improve the flow through, or from, the endless skirt.

Preferably the endless skirt presents an annular sealing surface to engage and seal to a duct interior presenting surface of the valve bonnet when in the closed position.

Preferably the endless skirt is supported from the central spindle by at least one vane.

Preferably there are a plurality of vanes.

Preferably at least a part of the flow conditioner extends into the endless skirt.

Preferably at least part of the flow conditioner extends either side of the at least one vane when the valve member is in the open or closed position and provides a relief into the flow conditioner which the at least one vane can pass into.

Preferably the valve is biased closed by the pressure of the fluid it is controlling.

Preferably there is a spring which biases the valve closed when no pressure is present.

Preferably the spring force is significantly less than the resultant forces of the pressure areas and design pressures of the valve

Preferably the spring provides higher pre-load force than the force which would act to open the valve from the presence of vacuum within the valve, and atmospheric pressure acting outside the valve

Preferably the first port and second port share the same or parallel axes, the valve bonnet and valve member being located at an at an angle between 15 and 75 degrees to the first port and second port axes.

Preferably the only part of the valve bonnet and actuator exposed to the fluid filled region of the duct is the face of the actuator including that part of the actuator the valve member seals to.

Preferably the only net pressure force the valve bonnet and actuator experience from the fluid is a net force in the axial direction of the valve bonnet and actuator.

Preferably the sealing perimeter of the valve member substantially matches the outer diameter of the valve bonnet, actuator and/or flow conditioner, such that when the valve member is in the closed position there is very little or none of the valve bonnet, actuator and/or flow conditioner exposed to the fluid, but so the sub assembly of the valve bonnet, actuator, and valve member can be removed from the valve body as the sub-assembly

Preferably the first sealing perimeter substantially matches the outer diameter of the valve bonnet, and the valve bonnet's outer diameter does not significantly deviate from that of the valve member's sealing parameter, such that there are no significant pressure areas (Net or otherwise) able to be acted upon by annular chamber pressure.

Preferably the valve member defines a sealing surface between the first diameter and a fourth diameter, and the area of the sealing surface is chosen for a given fluid pressure, and material hardnesses of the valve bonnet and valve member such that when in the closed position either or both of the valve bonnet and valve member undergo elastic, transient (localised plastic) or plastic deformation at least on the sealing surface.

Preferably the valve bonnet is retained to the valve body by any one or more of the following, a plurality of bolts, for example in a circular array, an internal circlip to over-engage the valve bonnet, and under engage the valve body, threading of the valve bonnet into the valve body, an external collar to over engage the valve bonnet, and under engage the valve body, an internal collar to over engage the valve bonnet, and under engage the valve body.

In a second aspect the present invention consists in a valve (1) to control flow of a fluid, comprising,
A valve body (2) with a first port (3) and a second port (4), the valve body being only defined by an outer wall (43) running between the first port (3) and the second port, the outer wall having an exterior surface (44), and through the thickness of the outer wall (43), directly opposite the exterior surface (44), the outer wall (43) has an interior surface (45), the interior surface defining a duct (25) between the first port (3) and the second port (4), and in use the interior surface (45) is in contact with the fluid, and the exterior surface (44) is not in contact with the fluid,
A valve bonnet (5) removably engaged to the valve body (2) between the first port (3) and second port (4), partly enclosing the duct (25) therebetween,
A valve member (6) having a closed position and an open position, with an endless skirt (7) supported from a central spindle (8) within the duct (25), the central spindle (8) in sliding and sealing engagement with the valve bonnet (5), the endless skirt (7) in sliding and sealing engagement at, and between, the open position and the closed position, with an interior periphery (9) of the duct, the endless skirt (7) to also engage and seal to the valve bonnet (5) when in the closed position, and define an opening (10) between the valve bonnet (5) and endless skirt (7) when in the open position, and when in the open position, fluid can flow through the opening (10) and through an interior diameter (30) of the endless skirt 7).

Preferably the valve (1) has a smooth flow through the cavity and valve member.

In another aspect the present invention consists in a valve to control flow of a fluid, comprising,
A valve body with a first port and a second port, the valve body being defined by an outer wall that defines a duct between the first port and the second port, the outer wall having an interior surface that is in fluid contact with the fluid, and through the thickness of the wall, directly opposing the interior surface, the outer wall has an exterior surface, the exterior surface not being in fluid contact with the fluid, the valve body having no walls that are in fluid contact on either side thereof,
A valve bonnet removably engaged to the valve body between the first port and second port, partly enclosing the duct therebetween,
A valve member having a closed position and an open position, with an endless skirt supported from a central spindle within the duct, the central spindle in sliding and sealing engagement with the valve bonnet, the endless skirt in sliding and sealing engagement at, and between, the open position and the closed position, with an interior periphery of the duct, the endless skirt to also engage and seal to the valve bonnet when in a closed position, and define an opening between the valve bonnet and endless skirt when in an open position, and when in the open position, fluid can flow through the opening and through an interior diameter of the endless skirt.

Preferably the valve body has no walls that are in fluid contact on either side thereof.

Preferably the valve body is only defined by the outer wall, the interior surface thereof is in contact with the fluid, the exterior surface is not in contact with the fluid.

Preferably the valve member defines a sealing surface between the first diameter and a fourth diameter, and the area of the sealing surface is chosen for a given fluid pressure, and material hardnesses of the valve bonnet and valve member such that when in the closed position either or both of the valve bonnet and valve member undergo elastic, transient (localised plastic) or plastic deformation at least on the sealing surface.

Preferably the valve bonnet is retained to the valve body by any one or more of the following, a plurality of bolts, for example in a circular array, an internal circlip to over-engage the valve bonnet, and under engage the valve body, threading of the valve bonnet into the valve body, an external collar to over engage the valve bonnet, and under engage the valve body, an internal collar to over engage the valve bonnet, and under engage the valve body.

Preferably there is a flow conditioner, as an extension into the duct, through which the spindle extends, from the actuator or valve bonnet.

Preferably the flow conditioner provides a tangential edge between the valve bonnet, or actuator, and the spindle.

Preferably there is an aperture in the flow conditioner through which the spindle extends.

Preferably there is a spindle seal in the aperture to slidingly seal the spindle.

Preferably the spindle seal is biased to seal by the pressure of the fluid.

Preferably the flow conditioner can be chosen based on the fluid type, for example dependant on viscosity, phase, inclusions, and the desired effect thereon, e.g. to keep the flow laminar, turbulent, remove or add cavitation, improve mixing or similar.

Preferably the flow conditioner aids in directing the fluid flow through the endless skirt and keeps the flow attached.

Preferably the flow path through the valve body between the first port and second port is constant cross section, or flow area.

Preferably when the valve member is an open position there is a continuous curvature provided by the tangential edges between the valve body and the upper most and lower most edges of the endless skirt, and the valve bonnet, via the flow conditioner, and the spindle.

Preferably there is a flow splitter adjacent to the valve member, and this may be upstream of the valve member or downstream of the valve member depending on the flow orientation through the valve.

Preferably the duct between the first port and the second port has a continuous curvature with no sharp edges, save for the flow splitter if present.

Preferably the flow splitter splits the flow vertically, or horizontally or both.

Preferably the flow splitter directs the flow to improve the flow through, or from, the endless skirt.

Preferably the endless skirt presents an annular sealing surface to engage and seal to a duct interior presenting surface of the valve bonnet when in the closed position.

Preferably the endless skirt is supported from the central spindle by at least one vane.

Preferably there are a plurality of vanes.

Preferably at least a part of the flow conditioner extends into the endless skirt.

Preferably at least part of the flow conditioner extends either side of the at least one vane when the valve member is in the open or closed position and provides a relief into the flow conditioner which the at least one vane can pass into.

In another aspect the present invention consists in a valve to control flow of a fluid, comprising or including,
A valve body with a first port, and a second port,
A valve bonnet removably engaged to the valve body between the first port and the second port, defining a duct with the valve body therebetween,
A valve member having a closed position and an open position, with an endless skirt supported from a central spindle within the cavity, the central spindle in sliding and sealing engagement with the valve bonnet, the endless skirt in sliding and sealing engagement at, and between, the open position and the closed position, with an interior periphery of the duct, the endless skirt to also engage and seal to the valve bonnet when in a closed position, and define an opening between the valve bonnet and endless skirt when in an open position, and when in the open position, fluid can flow through the opening and through an interior diameter of the endless skirt,
At least one fluid tight seal between an exterior of the central spindle and an interior of the valve bonnet, or between an exterior of the valve bonnet and an interior of the valve body, and
At least one fluid port from an exterior of the valve body to any one or more of the interior of the valve bonnet, or the exterior of the valve bonnet, to equalise the interior of the valve bonnet with the exterior of the valve body, or to detect a fluid leak past the at least one seal.

Preferable there is an actuator at least in part within the valve bonnet which the at least one fluid port allows to equalise with the exterior of the valve body as the actuator moves.

Preferably the at least one fluid tight seal is a primary spindle seal to seal between that part of the central spindle extending into the duct, and the remainder thereof, the primary spindle seal lying between an exterior of the central spindle, and an interior of the valve bonnet.

Preferably the at least one fluid port, is in fluid communication above the primary spindle seal to enable detection of a leak from the primary spindle seal.

Preferably the at least one fluid tight seal is a primary bonnet seal to seal between that part of the valve bonnet extending into the duct, and the remainder thereof, the primary bonnet seal lying between and exterior of the valve bonnet, and the interior of the valve body.

Preferably the at least one fluid port is a second fluid port that allows detection of pressure or fluid above the primary bonnet seal and therefore determines the presence of a leak of fluid past the primary bonnet seal

Preferably the at least one fluid port is a third fluid port in fluid communication between the primary spindle seal and the second fluid port to enable detection of a leak from either of both of the primary spindle seal or primary bonnet seal.

Preferably there is a secondary spindle seal up from the primary spindle seal.

Preferably the at least one fluid port can detect a leak from the primary and the secondary spindle seals.

Preferably the third fluid port is in fluid communication between the primary spindle seal and the secondary spindle seal.

Preferably the valve member defines a sealing surface between the first diameter and a fourth diameter, and the area of the sealing surface is chosen for a given fluid pressure, and material hardnesses of the valve bonnet and valve member such that when in the closed position either or both of the valve bonnet and valve member undergo elastic, transient (localised plastic) or plastic deformation at least on the sealing surface.

Preferably the valve bonnet is retained to the valve body by any one or more of the following, a plurality of bolts, for example in a circular array, an internal circlip to over-engage the valve bonnet, and under engage the valve body, threading of the valve bonnet into the valve body, an external collar to over engage the valve bonnet, and under engage the valve body, an internal collar to over engage the valve bonnet, and under engage the valve body.

Preferably there is a flow conditioner, as an extension into the duct, through which the spindle extends, from the actuator or valve bonnet.

Preferably the flow conditioner provides a tangential edge between the valve bonnet, or actuator, and the spindle.

Preferably there is an aperture in the flow conditioner through which the spindle extends.

Preferably there is a spindle seal in the aperture to slidingly seal the spindle.

Preferably the spindle seal is biased to seal by the pressure of the fluid.

Preferably the flow conditioner can be chosen based on the fluid type, for example dependant on viscosity, phase, inclusions, and the desired effect thereon, e.g. to keep the flow laminar, turbulent, remove or add cavitation, improve mixing or similar.

Preferably the flow conditioner aids in directing the fluid flow through the endless skirt and keeps the flow attached.

Preferably the flow path through the valve body between the first port and second port is constant cross section, or flow area.

Preferably when the valve member is an open position there is a continuous curvature provided by the tangential edges between the valve body and the upper most and lower most edges of the endless skirt, and the valve bonnet, via the flow conditioner, and the spindle.

Preferably there is a flow splitter adjacent to the valve member, and this may be upstream of the valve member or downstream of the valve member depending on the flow orientation through the valve.

Preferably the duct between the first port and the second port has a continuous curvature with no sharp edges, save for the flow splitter if present.

Preferably the flow splitter splits the flow vertically, or horizontally or both.

Preferably the flow splitter directs the flow to improve the flow through, or from, the endless skirt.

Preferably the endless skirt presents an annular sealing surface to engage and seal to a duct interior presenting surface of the valve bonnet when in the closed position.

Preferably the endless skirt is supported from the central spindle by at least one vane.

Preferably there are a plurality of vanes.

Preferably at least a part of the flow conditioner extends into the endless skirt.

Preferably at least part of the flow conditioner extends either side of the at least one vane when the valve member is in the open or closed position and provides a relief into the flow conditioner which the at least one vane can pass into.

In another aspect the present invention consists in a valve to control flow of a fluid, comprising or including,
A valve body with a first port, and a second port,
A valve bonnet removably engaged to the valve body between the first port and the second port, defining a duct therebetween,
A valve member having a closed position and an open position, with an endless skirt supported from a central spindle within the cavity, the central spindle in sliding and sealing engagement with the valve bonnet, the endless skirt in sliding and sealing engagement at, and between, the open position and the closed position, with an interior periphery of the duct, the endless skirt to also engage and seal to the valve bonnet when in a closed position, and define an opening between the valve bonnet and endless skirt when in an open position, and when in the open position, fluid can flow through the opening and through an interior diameter of the endless skirt,
At least one flushing channel that is in fluid communication from upstream of the endless skirt to downstream of the endless skirt, when in the open position, between the interior periphery of the duct and an external periphery of the endless skirt.

Preferably the at least one flushing channel is provided by a removable insert.

Preferably the removable insert is the same or smaller diameter than the valve bonnet and so can be extracted in the same direction from the valve body as the valve bonnet.

Preferably the removable insert is threadwise, pushfit, interference fit or otherwise secured in the valve body.

Preferably there are a plurality of flushing channels.

Preferably the valve member defines a sealing surface between the first diameter and a fourth diameter, and the area of the sealing surface is chosen for a given fluid pressure, and material hardnesses of the valve bonnet and valve member such that when in the closed position either or both of the valve bonnet and valve member undergo elastic, transient (localised plastic) or plastic deformation at least on the sealing surface.

Preferably the valve bonnet is retained to the valve body by any one or more of the following, a plurality of bolts, for example in a circular array, an internal circlip to over-engage the valve bonnet, and under engage the valve body, threading of the valve bonnet into the valve body, an external collar to over engage the valve bonnet, and under engage the valve body, an internal collar to over engage the valve bonnet, and under engage the valve body.

Preferably there is a flow conditioner, as an extension into the duct, through which the spindle extends, from the actuator or valve bonnet.

Preferably the flow conditioner provides a tangential edge between the valve bonnet, or actuator, and the spindle.

Preferably there is an aperture in the flow conditioner through which the spindle extends.

Preferably there is a spindle seal in the aperture to slidingly seal the spindle.

Preferably the spindle seal is biased to seal by the pressure of the fluid.

Preferably the flow conditioner can be chosen based on the fluid type, for example dependant on viscosity, phase, inclusions, and the desired effect thereon, e.g. to keep the flow laminar, turbulent, remove or add cavitation, improve mixing or similar.

Preferably the flow conditioner aids in directing the fluid flow through the endless skirt and keeps the flow attached.

Preferably the flow path through the valve body between the first port and second port is constant cross section, or flow area.

Preferably when the valve member is an open position there is a continuous curvature provided by the tangential edges between the valve body and the upper most and lower most edges of the endless skirt, and the valve bonnet, via the flow conditioner, and the spindle.

Preferably there is a flow splitter adjacent to the valve member, and this may be upstream of the valve member or downstream of the valve member depending on the flow orientation through the valve.

Preferably the duct between the first port and the second port has a continuous curvature with no sharp edges, save for the flow splitter if present.

Preferably the flow splitter splits the flow vertically, or horizontally or both.

Preferably the flow splitter directs the flow to improve the flow through, or from, the endless skirt.

Preferably the endless skirt presents an annular sealing surface to engage and seal to a duct interior presenting surface of the valve bonnet when in the closed position.

Preferably the endless skirt is supported from the central spindle by at least one vane.

Preferably there are a plurality of vanes.

Preferably at least a part of the flow conditioner extends into the endless skirt.

Preferably at least part of the flow conditioner extends either side of the at least one vane when the valve member is in the open or closed position, and provides a relief into the flow conditioner which the at least one vane can pass into.

In yet another aspect the present invention consists in a valve to control flow of a fluid, comprising or including,
A valve body with at least one inlet, and at least one outlet,
A valve bonnet removably engaged to the valve body between the at least one inlet and at least one outlet, defining a cavity therebetween,
A valve member having a closed position and an open position, with an endless skirt supported from a central spindle within the cavity, the central spindle in sliding and sealing engagement with the valve bonnet, the endless skirt in sliding and sealing engagement at, and between, the open position and the closed position, with an interior periphery of the cavity, the endless skirt to also engage and seal to the valve bonnet when in a closed position, and define an opening between the valve bonnet and endless skirt when in an open position, and when in the open position, fluid can flow through the opening and through an interior diameter of the endless skirt,
The valve member when in the open position presenting a tangential edge between any one or more of,
An uppermost stream edge of the endless skirt,
A downmost stream edge of the endless skirt, and/or
A downstream edge of the valve bonnet transition to the spindle,

Such that a valve is provided that has a smooth flow through the cavity and valve member.

Preferably the interior diameter defines an inner chamber.

Preferably the downstream pressure area defined by the spindle seal diameter is larger, but not more than 20% larger, than the downstream facing pressure area, paired with a actuator bias that is of sufficient force to hold the valve closed against a vacuum condition in the inner chamber.

Preferably the valve body and valve bonnet or actuator define an annular chamber that is fluidly connected to the inner chamber when the valve member is in the open position.

In one form of the present invention the annular chamber is in the inlet volume and leads to the valve member when in the open position, and the inner chamber leads to the outlet volume. However in other configurations this may be the opposite and the inlet volume leads to the inner chamber, and this in turn, when the valve is in the open position leads to the annular chamber which is in the outlet volume.

Preferably the seal pack, which seals between the process media and atmosphere, is affixed into the valve bonnet from the fluid side of the valve bonnet.

Preferably no part of the annular chamber the valve member slides in resides within the diameter of a seal between the valve body and valve member.

Preferably pressure of the fluid acts on an overall surface area of the valve member to bias it open, or an overall surface area of the valve member to bias it closed, or there is an overall balance of surface areas of the valve member such that is it neutrally biased by the pressure of the fluid.

Preferably the overall surface area is provided by an upstream facing surface on an outside diameter of the endless member.

Preferably the overall surface area is provided by a downstream facing surface on an outside diameter of the endless member.

Preferably the valve is biased closed by the pressure of the fluid it is controlling.

Alternatively, the valve is balanced as to enable easier opening.

Preferably the first pressure area defined by the frontal area (for example, diameter) of the spindle is matched to the second pressure area defined by the difference between the face sealing diameter and the seal between the body and endless skirt, such that the valve member is unbiased by the fluid pressure upstream and downstream of it.

Alternatively, the first pressure area defined by the frontal area of the spindle (for example the diameter) is larger than the second pressure area defined by the difference between the face sealing diameter and the seal between the body and endless skirt to ensure pressure assisted closing of the valve member when the larger pressure is on either side of the valve.

Preferably the spindle allows fluid to flow (whether the same or different) through its interior, into, or towards, the interior diameter.

Preferably the valve member defines a sealing surface between the first diameter and a fourth diameter, and the area of the sealing surface is chosen for a given fluid pressure, and material hardnesses of the valve bonnet and valve member such that when in the closed position either or both of the valve bonnet and valve member undergo elastic, transient (localised plastic) or plastic deformation at least on the sealing surface.

Preferably the valve bonnet is retained to the valve body by any one or more of the following, a plurality of bolts, for example in a circular array, an internal circlip to over-engage the valve bonnet, and under engage the valve body, threading of the valve bonnet into the valve body, an external collar to over engage the valve bonnet, and under engage the valve body, an internal collar to over engage the valve bonnet, and under engage the valve body.

Preferably there is a flow conditioner, as an extension into the duct, through which the spindle extends, from the actuator or valve bonnet.

Preferably the flow conditioner provides a tangential edge between the valve bonnet, or actuator, and the spindle.

Preferably there is an aperture in the flow conditioner through which the spindle extends.

Preferably there is a spindle seal in the aperture to slidingly seal the spindle.

Preferably the spindle seal is biased to seal by the pressure of the fluid.

Preferably the flow conditioner can be chosen based on the fluid type, for example dependant on viscosity, phase, inclusions, and the desired effect thereon, e.g. to keep the flow laminar, turbulent, remove or add cavitation, improve mixing or similar.

Preferably the flow conditioner aids in directing the fluid flow through the endless skirt and keeps the flow attached.

Preferably the flow path through the valve body between the first port and second port is constant cross section, or flow area.

Preferably when the valve member is an open position there is a continuous curvature provided by the tangential edges between the valve body and the upper most and lower most edges of the endless skirt, and the valve bonnet, via the flow conditioner, and the spindle.

Preferably there is a flow splitter adjacent to the valve member, and this may be upstream of the valve member or downstream of the valve member depending on the flow orientation through the valve.

Preferably the duct between the first port and the second port has a continuous curvature with no sharp edges, save for the flow splitter if present.

Preferably the flow splitter splits the flow vertically, or horizontally or both.

Preferably the flow splitter directs the flow to improve the flow through, or from, the endless skirt.

Preferably the endless skirt presents an annular sealing surface to engage and seal to a duct interior presenting surface of the valve bonnet when in the closed position.

Preferably the endless skirt is supported from the central spindle by at least one vane.

Preferably there are a plurality of vanes.

Preferably at least a part of the flow conditioner extends into the endless skirt.

Preferably at least part of the flow conditioner extends either side of the at least one vane when the valve member is in the open or closed position.

In an alternative design, the face sealing diameter and seal between the skirt and body are matched as to not result generate a pressure area, an additional seal between the skirt and valve body is included—the difference in pressure areas between the two body-skirt seals matching the stem seal area—resulting in a totally neutrally balanced valve member.

With the exception of the flow deflector and sealing system mounted to the wetted side of the bonnet, preferably there are no bolted or threaded connections between the face of the bonnet exposed to the inner chamber, and the mounting connection of the bonnet to the valve body.

In another aspect the present invention may be said to broadly consist in a valve to control flow of a fluid, comprising or including,
A valve body with at least one inlet, and at least one outlet,
A valve bonnet removably engaged to the valve body between the at least one inlet and at least one outlet, defining a cavity therebetween,
A valve member having a closed position and an open position, with an endless skirt supported from a central spindle within the cavity, the central spindle in sliding and sealing engagement with the valve bonnet, the endless skirt in sliding and sealing engagement at, and between, the open position and the closed position, with an interior periphery of the cavity, the endless skirt to also engage and seal to the valve bonnet when in a closed position, and define an opening between the valve bonnet and endless skirt when in an open position, and when in the open position, fluid can flow through the opening and through an interior diameter of the endless skirt, Such that a valve is provided that has a smooth flow through the cavity and valve member, and wherein, the at least one inlet and the at least one outlet share the same or parallel axes, the valve bonnet and valve member being located at an at an angle between 15 and 75 degrees to the inlet and outlet axes.

In another aspect the present invention consists in a method of providing a valve (1) to control flow of a fluid under pressure, comprising,
Providing a valve body (2) with a first port (3), and a second port (4), to, in part, define a duct (25) therebetween, to duct the flow of the fluid between the first port and the second port,
Providing a valve bonnet (5) removably engaged to the valve body (2) between the first port and the second port, to further define the duct,
Providing a valve member (6) having an endless skirt (7) supported by a central spindle (8) within the duct from the valve bonnet (5), the endless skirt (7) having an outer periphery, which the valve body (2) defines an annular chamber (38) about, and the endless skirt (7) having an inner periphery (9) which defines an inner chamber (42), the valve member (6) having a closed position to prevent flow of fluid, and an open position to allow flow of fluid,
Configuring the endless skirt (7), when in the closed position, to seal against the valve bonnet at a first sealing diameter (D1), the endless skirt in sliding and sealing engagement at, and between, the open position and the closed position, with an interior periphery of the annular chamber at a second sealing diameter (D2), the first sealing diameter (D1) greater than the second sealing diameter (D2), a first pressure area defined between the first sealing diameter and the second sealing diameter, the first pressure area on receipt of fluid under pressure providing a bias toward the closed position,

The endless skirt when in the open position defining an opening between the valve bonnet and endless skirt to allow fluid flow between the first port, via the opening and an interior diameter of the endless skirt, and the second port,
the central spindle in sliding and sealing engagement with the valve bonnet at a third sealing diameter (D3), less than the second sealing diameter, the third sealing diameter (D3) defining a second pressure area, the second pressure area on receipt of fluid under pressure providing a bias toward the closed position, such that a valve is provided that is biased towards the closed position when in either the open position or closed position.

In another aspect the present invention consists in a method of operating a valve (1) to control flow of a fluid, comprising,
Providing a valve body (2) with a first port (3) and a second port (4), the valve body being only defined by an outer wall (43) running between the first port (3) and the second port, the outer wall having an exterior surface (44), and through the thickness of the outer wall (43), directly opposite the exterior surface (44), the outer wall (43) has an interior surface (45), the interior surface defining a duct (25) between the first port (3) and the second port (4), and in use the interior surface (45) is in contact with the fluid, and the exterior surface (44) is not in contact with the fluid,
Providing a valve bonnet (5) removably engaged to the valve body (2) between the first port (3) and second port (4), partly enclosing the duct (25) therebetween,
Providing a valve member (6) having a closed position and an open position, with an endless skirt (7) supported from a central spindle (8) within the duct (25), the central spindle (8) in sliding and sealing engagement with the valve bonnet (5), the endless skirt (7) in sliding and sealing engagement at, and between, the open position and the closed position, with an interior periphery (9) of the duct, the endless skirt (7) to also engage and seal to the valve bonnet (5) when in the closed position, and define an opening (10) between the valve bonnet (5) and endless skirt (7) when in the open position, and when in the open position, fluid can flow through the opening (10) and through an interior diameter (30) of the endless skirt 7),
Such that a valve (1) is provided that has a smooth flow through the cavity and valve member.

In another aspect the present invention consists in a method of operating a valve to control flow of a fluid, comprising,
Providing a valve body with a first port and a second port, the valve body being defined by an outer wall that defines a duct between the first port and the second port, the outer wall having an interior surface that is in fluid contact with the fluid, and through the thickness of the wall, directly opposing the interior surface, the outer wall has an exterior surface, the exterior surface not being in fluid contact with the fluid, the valve body having no walls that are in fluid contact on either side thereof,
Providing a valve bonnet removably engaged to the valve body between the first port and second port, partly enclosing the duct therebetween,
Providing a valve member having a closed position and an open position, with an endless skirt supported from a central spindle within the duct, the central spindle in sliding and sealing engagement with the valve bonnet, the endless skirt in sliding and sealing engagement at, and between, the open position and the closed position, with an interior periphery of the duct, the endless skirt to also engage and seal to the valve bonnet when in a closed position, and define an opening between the valve bonnet and endless skirt when in an open position, and when in the open position, fluid can flow through the opening and through an interior diameter of the endless skirt,
Such that a valve is provided that has a smooth flow through the cavity and valve member.

In another aspect the present invention consists in a method of operating a valve to control flow of a fluid, comprising or including,
Providing a valve body with a first port, and a second port,
Providing a valve bonnet removably engaged to the valve body between the first port and the second port, defining a duct with the valve body therebetween,
Providing a valve member having a closed position and an open position, with an endless skirt supported from a central spindle within the cavity, the central spindle in sliding and sealing engagement with the valve bonnet, the endless skirt in sliding and sealing engagement at, and between, the open position and the closed position, with an interior periphery of the duct, the endless skirt to also engage and seal to the valve bonnet when in a closed position, and define an opening between the valve bonnet and endless skirt when in an open position, and when in the open position, fluid can flow through the opening and through an interior diameter of the endless skirt,
Providing at least one fluid tight seal between an exterior of the central spindle and an interior of the valve bonnet, or between an exterior of the valve bonnet and an interior of the valve body, and
Providing at least one fluid port from an exterior of the valve body to any one or more of the interior of the valve bonnet, or the exterior of the valve bonnet, to equalise the interior of the valve bonnet with the exterior of the valve body, or to detect a fluid leak past the at least one seal.

In another aspect the present invention consists in a method of operating a valve to control flow of a fluid, comprising or including,
Providing a valve body with a first port, and a second port,
Providing a valve bonnet removably engaged to the valve body between the first port and the second port, defining a duct therebetween,
Providing a valve member having a closed position and an open position, with an endless skirt supported from a central spindle within the cavity, the central spindle in sliding and sealing engagement with the valve bonnet, the endless skirt in sliding and sealing engagement at, and between, the open position and the closed position, with an interior periphery of the duct, the endless skirt to also engage and seal to the valve bonnet when in a closed position, and define an opening between the valve bonnet and endless skirt when in an open position, and when in the open position, fluid can flow through the opening and through an interior diameter of the endless skirt,
At least one flushing channel that is in fluid communication from upstream of the endless skirt to downstream of the endless skirt, when in the open position, between the interior periphery of the duct and an external periphery of the endless skirt.

In another aspect the present invention consists in a method of providing a valve to control flow of a fluid, comprising or including,
Providing a valve body with at least one inlet, and at least one outlet,
Providing a valve bonnet removably engaged to the valve body between the at least one inlet and at least one outlet, defining a cavity therebetween,
Providing a valve member having a closed position and an open position, with an endless skirt of constant outer cross-section, supported from a central spindle within the cavity, the central spindle in sliding and sealing engagement with the valve bonnet, the endless skirt in sliding and sealing engagement at, and between, the open position and the closed position, with an interior periphery of the cavity, the endless skirt to also engage and seal to the valve bonnet when in a closed position, and define an opening between the valve bonnet and endless skirt when in an open position, and when in the open position, fluid can flow through the opening and through an interior diameter of the endless skirt,
the valve member when in the open position presents a tangential edge between anyone or more of,
An uppermost stream edge of the endless skirt,
A downmost stream edge of the endless skirt, and/or
A downstream edge of the valve bonnet transition to the spindle, Such that a valve is provided that has a smooth flow through the cavity and valve member.

Preferably the valve body has a valve bonnet aperture to which the valve bonnet is operatively connected to seal the cavity, other than the at least one inlet and at least one outlet.

Preferably the valve bonnet contains or holds an actuator for the spindle to move the valve member between the open position and closed position.

Preferably the actuator may be actuated by any one or more of the following, gas, fluid, magnetic, mechanical or electrical.

Preferably the actuator, or part thereof, is held or contained within the valve body by the valve bonnet and extends at least in part into the cavity.

Preferably the actuator is integral with the bonnet and valve member.

Preferably the actuator, valve bonnet and valve member are a unitary subassembly that is removable from the valve body.

Preferably the valve body and valve bonnet or actuator define an annular chamber that is fluidly connected to the inner chamber when the valve member is in the open position.

In one form of the present invention the annular chamber is in the inlet volume and leads to the valve member when in the open position, and the inner chamber leads to the outlet volume. However in other configurations this may be the opposite and the inlet volume leads to the inner chamber, and this in turn, when the valve is in the open position leads to the annular chamber which is in the outlet volume.

Preferably, the valve member and sealing elements alone separate the inlet and outlet volumes.

Preferably there is a flow conditioner, as an extension into the cavity through which the spindle extends, from the actuator or valve bonnet.

Preferably the flow conditioner provides the tangential edge between valve bonnet, or actuator, and the spindle.

Preferably there is an aperture in the flow conditioner through which the spindle extends.

Preferably there is a spindle seal in the aperture to slidingly seal the spindle.

Preferably the spindle seal is biased to seal by the pressure of the fluid.

Preferably, the position at which the spindle seal acts on the spindle is at least partially encircled by the cavity.

Preferably the seal pack, which seals between the process media and atmosphere, is affixed into the valve bonnet from the fluid side of the valve bonnet.

Preferably no part of the annular cavity within which the valve member slides resides within the diameter of a seal between the valve body and valve member

Preferably the flow conditioner can be chosen based on the fluid type, for example dependant on viscosity, phase, inclusions, and the desired effect thereon, e.g. to keep the flow laminar, turbulent, remove or add cavitation, improve mixing or similar.

Preferably the flow conditioner aids in directing the fluid flow through, or from, the endless skirt and keeps the flow attached.

Preferably the flow path through the valve body from the at least one inlet to the at least one outlet is constant cross section.

Preferably when the valve member is an open position there is a continuous curvature provided by the tangential edges between the valve body and the upper most and lower most edges of the endless skirt, and the valve bonnet, via the flow conditioner, and the spindle.

Preferably there is a flow splitter adjacent to the valve member, and this may be upstream of the valve member or downstream of the valve member depending on the flow orientation through the valve.

Preferably the cavity between the at least one inlet and the at least one outlet has a continuous curvature with no sharp edges, save for the flow splitter if present.

Preferably the flow splitter splits the flow vertically, or horizontally or both.

Preferably the flow splitter directs the flow to improve the flow through, or from, the endless skirt.

Preferably the endless skirt presents an annular sealing surface to engage and seal to a cavity interior presenting surface of the valve bonnet when in the closed position.

Preferably the endless skirt is supported from the central spindle by at least one vane. Preferably there are a plurality of vanes.

Preferably pressure of the fluid acts on an overall surface area of the valve member to bias it open, or an overall surface area of the valve member to bias it closed, or there is an overall balance of surface areas of the valve member that is it neutrally biased by the pressure of the fluid.

Preferably the overall surface area is provided by an upstream facing surface on an outside diameter of the endless member.

Preferably the overall surface area is provided by a downstream facing surface on an outside diameter of the endless member.

Preferably the valve is biased closed by the pressure of the fluid it is controlling.

Alternatively the valve is balanced as to enable easier opening,

Preferably the first pressure area defined by the frontal area (for example, diameter) of the spindle is matched to the second pressure area defined by the difference between the face sealing diameter and the seal between the body and endless skirt, such that the valve member is unbiased by the fluid pressure upstream and downstream of it.

Alternatively, the first pressure area defined by the frontal area of the spindle (for example the diameter) is larger than the second pressure area defined by the difference between the face sealing diameter and the seal between the body and endless skirt to ensure pressure assisted closing of the valve member when the larger pressure is on either side of the valve.

In an alternative design, the face sealing diameter and seal between the skirt and body are matched as to not result generate a pressure area, an additional seal between the skirt and valve body is included—the difference in pressure areas between the two body-skirt seals matching the stem seal area—resulting in a totally neutrally balanced valve member.

Preferably the spindle allows fluid to flow (whether the same or different) through its interior, into, or towards, or from the interior diameter.

Preferably the at least one inlet and at least one outlet share the same or parallel axes, the valve bonnet and valve member being located at an at an angle between 15 and 75 degrees to the inlet and outlet axes.

Preferably the valve bonnet and actuator are not exposed to the fluid filled region of the cavity save for that part of the face of the actuator the valve member seals to such as the flow conditioner.

Preferably the only net pressure force the valve bonnet and actuator experience from the fluid is a net force in the axial direction of the valve bonnet and actuator.

Preferably the sealing perimeter of the valve member substantially matches the outer diameter of the valve bonnet, actuator and/or flow conditioner, such that when the valve member is in the closed position there is very little or none of the valve bonnet, actuator and/or flow conditioner exposed to the fluid.

In another aspect the present invention consists in a valve as described herein with reference to any one or more of the accompanying drawings.

In another aspect the present invention consists in a method of providing a valve as described herein with reference to any one or more of the accompanying drawings.

As used herein the term “and/or” means “and” or “or”, or both.

As used herein “(s)” following a noun means the plural and/or singular forms of the noun.

The term “comprising” as used in this specification means “consisting at least in part of”. When interpreting statements in this specification which include that term, the features, prefaced by that term in each statement, all need to be present, but other features can also be present. Related terms such as “comprise” and “comprised” are to be interpreted in the same manner.

It is intended that reference to a range of numbers disclosed herein (for example, 1 to 10) also incorporates reference to all rational numbers within that range (for example, 1, 1.1, 2, 3, 3.9, 4, 5, 6, 6.5, 7, 8, 9 and 10) and also any range of rational numbers within that range (for example, 2 to 8, 1.5 to 5.5 and 3.1 to 4.7).

The entire disclosures of all applications, patents and publications, cited above and below, if any, are hereby incorporated by reference.

This invention may also be said broadly to consist in the parts, elements and features referred to or indicated in the specification of the application, individually or collectively, and any or all combinations of any two or more of said parts, elements and features, and where specific integers are mentioned herein which have known equivalents in the art to which this invention relates, such known equivalents are deemed to be incorporated herein as if individually set forth.

Other aspects of the invention may become apparent from the following description which is given by way of example only and with reference to the accompanying drawings.

### BRIEF DESCRIPTION OF THE DRAWINGS

Preferred forms of the present invention will now be described with reference to the accompanying drawings in which;

FIG. 1 Shows an outside side view of an in-line two-way valve in keeping with the present invention,

FIG. 2 Shows a similar view as FIG. 1 with the valve bonnet, actuator and valve member removed as a sub-assembly,

FIG. 3 Shows a horizontal cross-section in plan view of the valve in FIG. 1, showing the annular chamber about the valve actuator, and the flow splitter,

FIG. 4 Shows an end view of the present invention, which may be an inlet (or outlet) to the valve, showing a flow splitter,

FIG. 5 Shows a vertical cross section in side view of the valve showing the actuator and valve element in the closed position,

FIG. 6 Shows a vertical cross section in side view of the valve showing the actuator and valve element in the open position,

FIG. 7 Shows an isometric end view of the valve element,

FIG. 8 Shows Detail B of FIG. 6, a close up cross section of the valve member, and the difference in outside diameter (first diameter) and skirt diameter (second diameter) forming a first pressure area to bias the valve closed,

FIG. 9 Shows a vertical cross section similar to that of FIG. 5, showing the first pressure area and second pressure area the fluid pressure acts on,

FIG. 10 Shows a schematic of the pressure areas of FIG. 9 and the directions of resulting forces on those areas, in this case for the schematic shown in FIG. 20,

FIG. 11 Shows an exploded isometric view, similar to that of FIG. 2, of the sub-assembly of the valve bonnet, actuator, valve element and flow conditioner in further exploded view,

FIG. 12 Shows a vertical cross section of the sub-assembly of the valve bonnet, actuator, flow conditioner and valve element in vertical cross section in the closed position,

FIG. 13 Shows a vertical cross section of the sub-assembly of the valve bonnet, actuator, flow conditioner and valve element in vertical cross section in the open position,

FIG. 14 Shows a schematic of the valve of in vertical cross section in the closed position,

FIG. 15 Shows the schematic of the valve of FIG. 14 in vertical cross section in the open position,

FIG. 16 Shows an outside side view of a ninety-degree two-way valve variation in keeping with the present invention,

FIG. 17 Shows an isometric side view of a rotary actuator with a helical path to act and move the spindle, and

FIG. 18 Shows a cross section of the rotary actuator of FIG. 17,

FIG. 19 Shows a schematic of Detail C from FIG. 19 when the present invention is configured to be pressure biased closed, an overall pressure surface area is acted on by the pressure fluid to act to close the valve,

FIG. 20 Shows a schematic of Detail C, when the present invention is configured to be fully balanced as to enable easier opening, the inlet and outlet pressures acting on the valve member endless skirt cancelling each other out, the main closing force coming from the pressure acting on the valve stem,

FIG. 21 Shows a schematic of Detail C, when the present invention is configured to be fully neutrally balanced, having an external port to atmosphere to do so,

FIG. 22 Shows a schematic axial cross section of the valve member similar to Detail C, showing the annular chamber, inner chamber, and valve body, showing the resultant pressure peripheries (in this case diameters due to the circular nature of the valve) which define the various pressure areas, to bias the valve member open, closed, or neutral by pressure of the fluid,

FIG. 23 Shows a vertical cross section through a valve, with various ports for pressure relief and leak detection,

FIG. 24 Shows a cross section through a valve showing a replaceable wear insert for flushing,

FIG. 25 Shows a similar view to that of FIG. 24 showing a valve with body flushing channels around the periphery of the endless skirt of the valve member,

FIG. 26 Shows a similar view to that of FIG. 25 with a valve body seal,

FIG. 27 Shows a similar view to that of FIG. 26 with grooves in the endless skirt to allow for flushing the endless skirt periphery when in the open position,

FIG. 28 Shows in cross section detail the valve of FIG. 24 in a closed position, and the flushing insert below the valve member, as well as the internal circlip bonnet retention of FIG. 30, and also shows the flow splitter,

FIG. 29 Shows the valve of FIG. 28 with the valve in the open position and the clearance provided to flush around the outer periphery of the valve member, as well as the internal circlip bonnet retention of FIG. 30,

FIG. 30 Shows at A) and isometric exploded view, and at B) a vertical cross section view of a valve of the present invention where the valve bonnet and unitary assembly is retained by an internal circlip,

FIG. 31 Shows at A) and isometric exploded view, and at B) a vertical cross section view of a valve of the present invention where the valve bonnet is retained by threaded connection to the valve body,

FIG. 32 Shows at A) and isometric exploded view, and at B) a vertical cross section view of a valve of the present invention where the valve bonnet is retained by an external collar,

FIG. 33 Shows at A) and isometric exploded view, and at B) a vertical cross section view of a valve of the present invention where the valve bonnet is retained by an internal collar,

FIG. 34 Shows a close up vertical cross section of the valve member and bonnet interface, the various pressure diameters involved for specific sealing geometries, and

FIG. 35 Shows an end view of the flow conditioner on the end of the valve bonnet when seen in Direction A of FIG. 5.

### DETAILED DESCRIPTION OF THE INVENTION

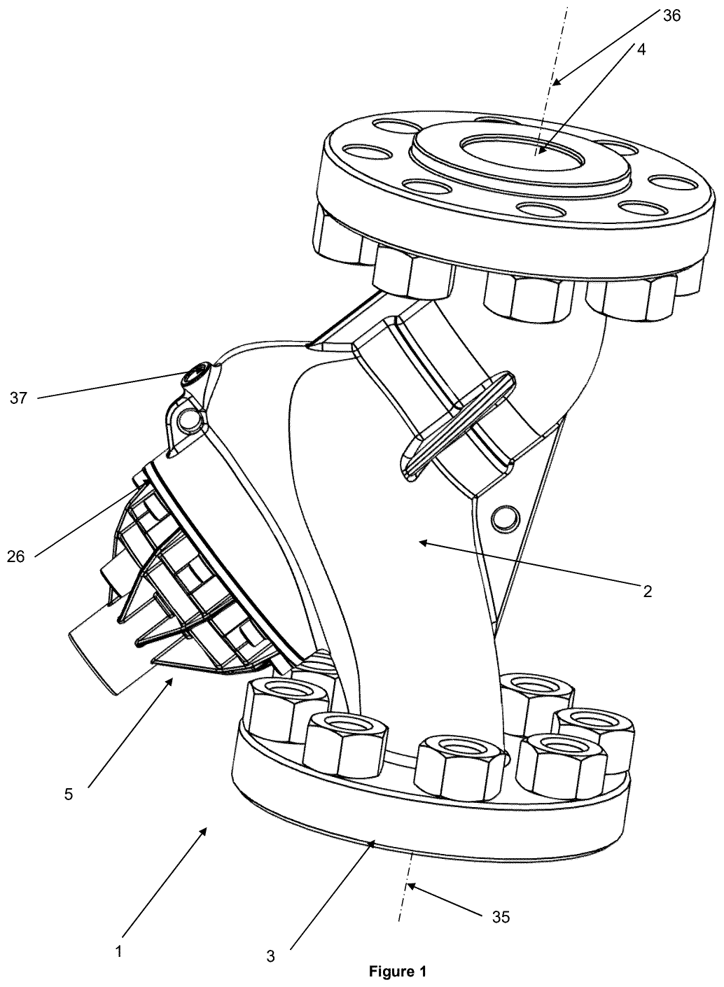

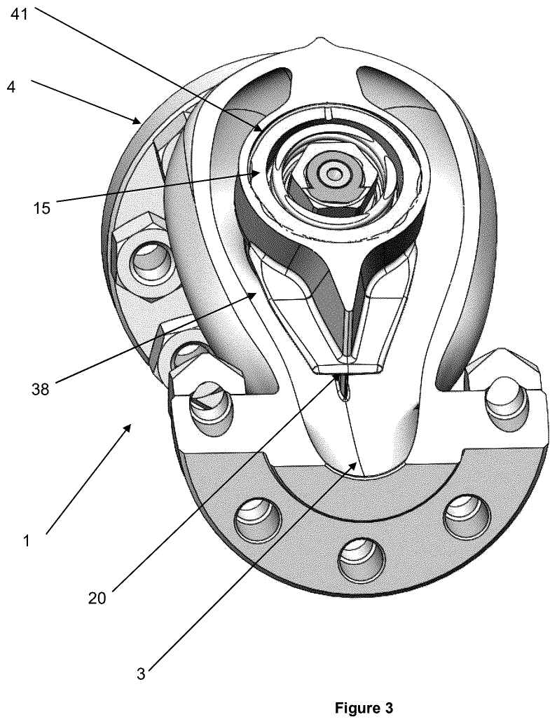

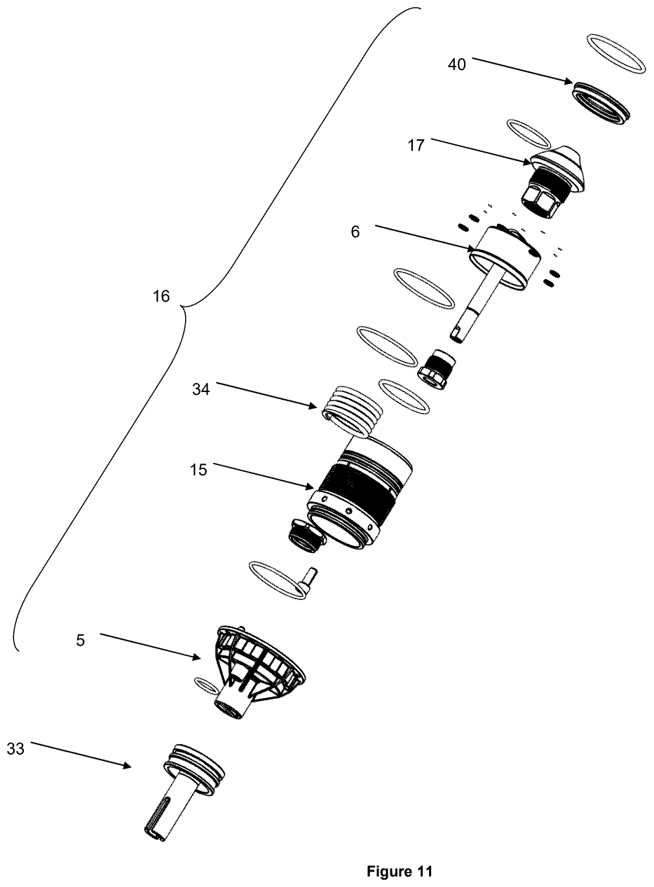

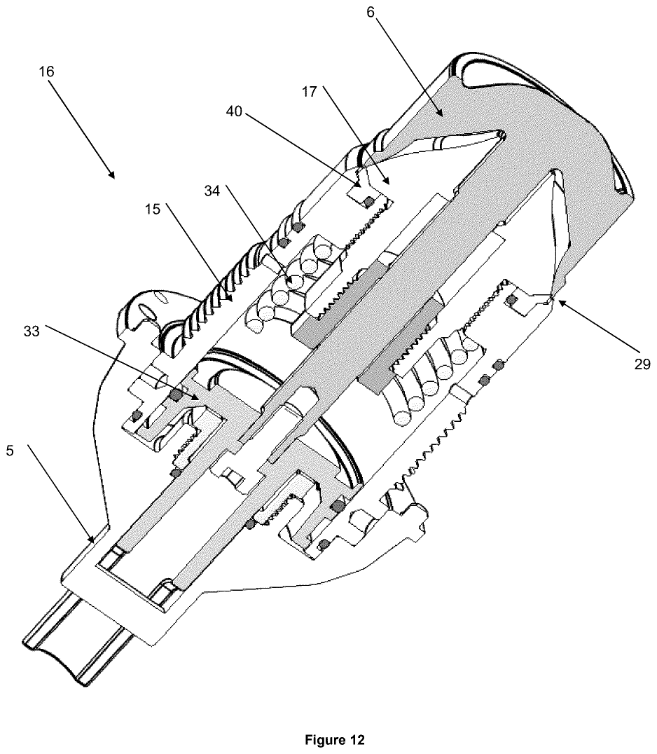

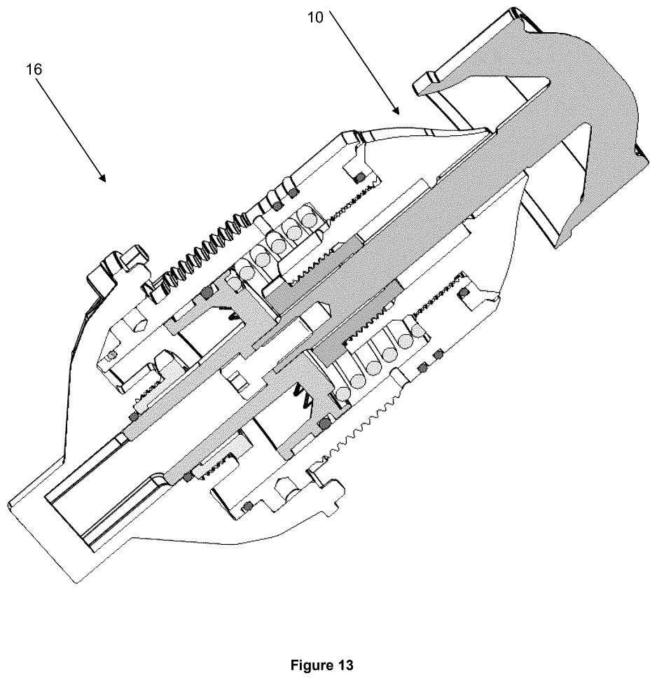

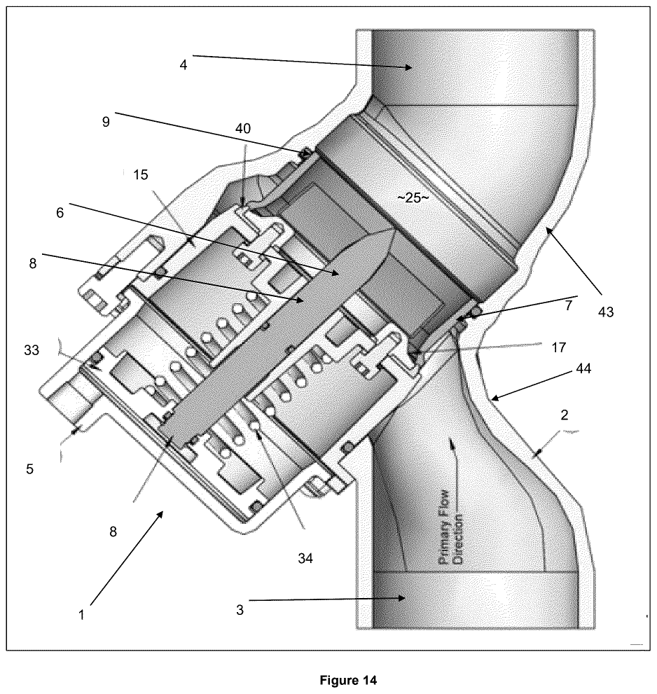

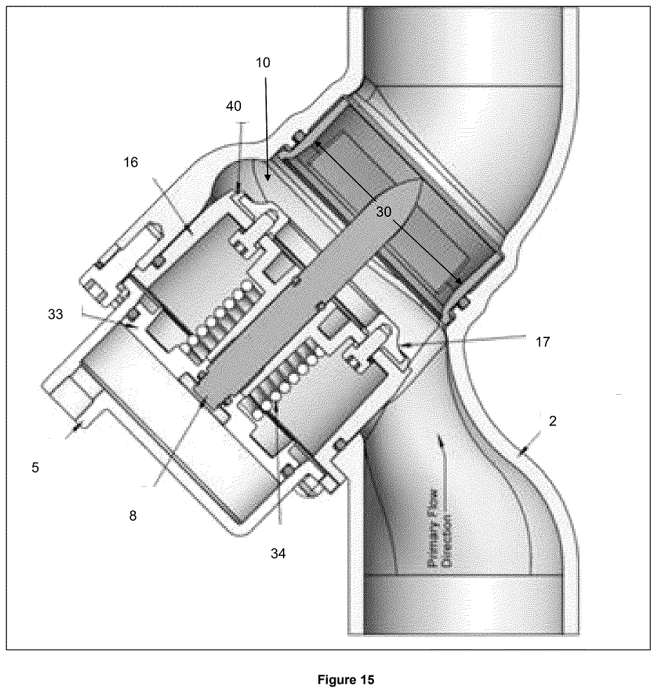

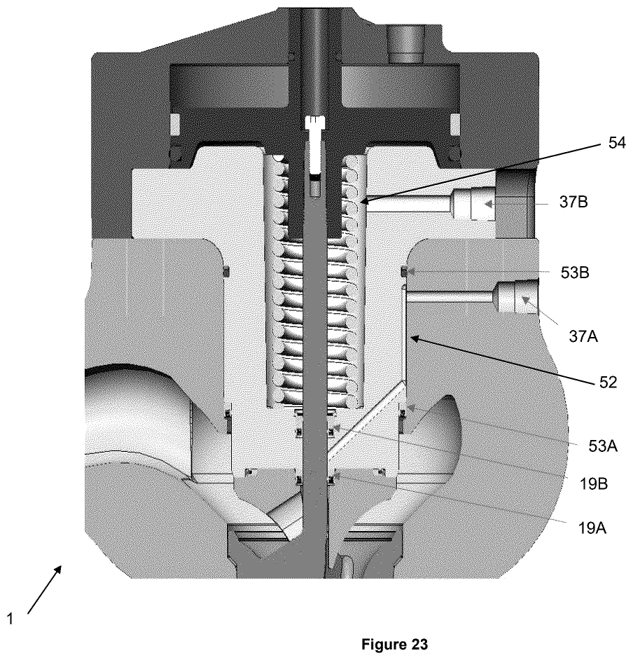

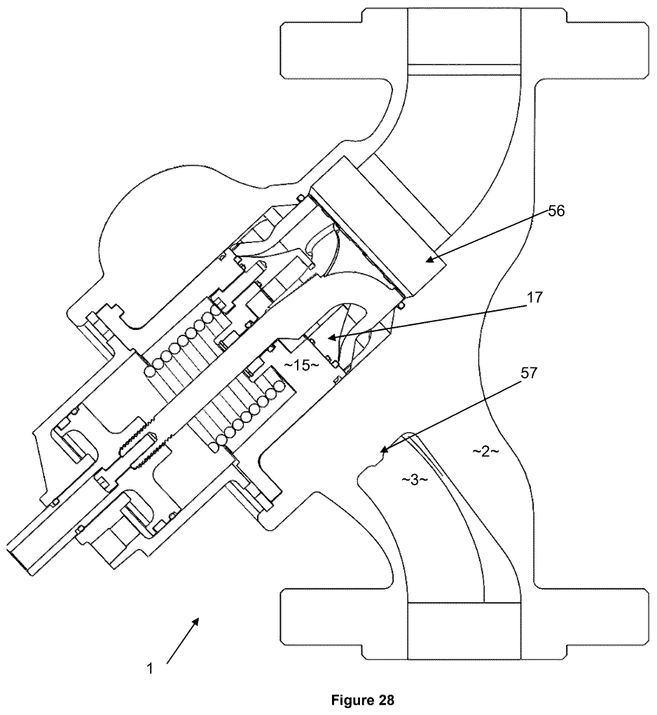

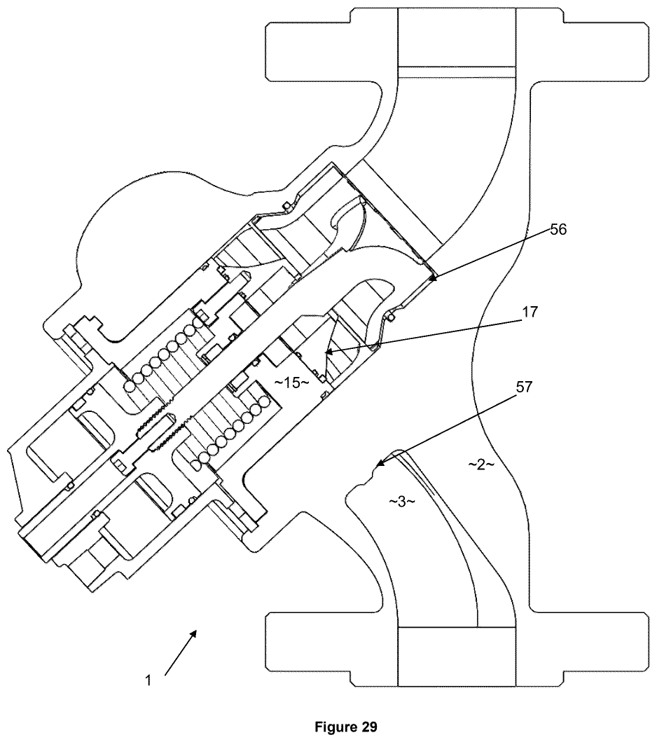

Preferred embodiments of the present invention will now be described with reference to FIGS. 1 through 35.

The valve of the present invention may be used in many areas including sanitary conditions such as food and beverage, pharmaceuticals and life science, potable water, and building technology, hydrogen, semiconductor/electronics, fine chemicals, liquified natural gas, offshore oil and gas, and basic chemicals, and for gases, fluids and mixed media. As such, there is a wide variety of uses and applications of providing an improved valve, in particular one which is easier to clean, compact, easy to service, small overall size, and reduces build-up of materials in the valve.

The valve 1 is capable of controlling the flow of a fluid from a first port 3, for example as an inlet, to a second port 4, for example as an outlet. The fluid may be a liquid, gas, or combination of both, and may contain solids depending on the situational needs.

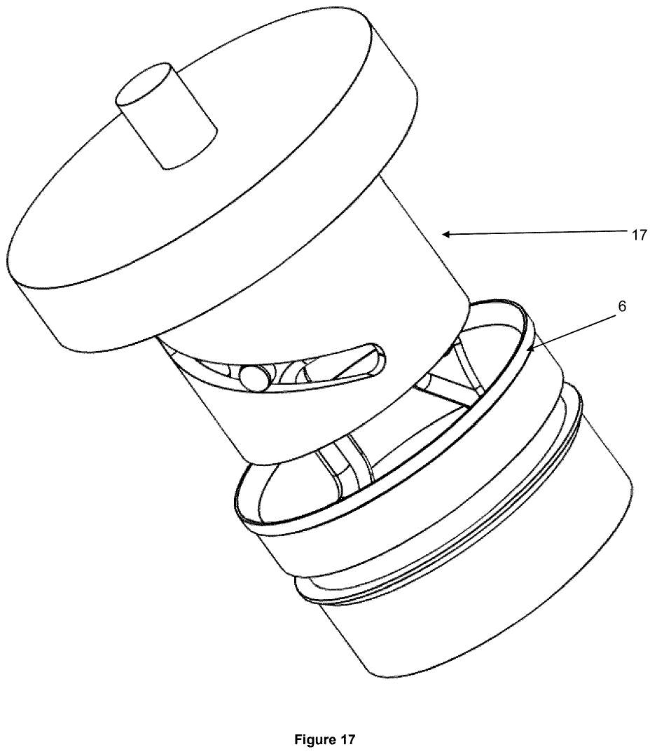

The valve 1 may be used as an on or off valve. That is, it either permits full flow of the fluid under control, or it prevents fluid flow. In this form the valve 1 does not throttle the flow of the fluid, except when it is moving from an open position 28 to a closed position 27, or vice versa, but normally in this configuration it cannot stop in between. In other forms the valve 1 may be used as control valve, whereby it can control the flow of fluid between the first port 3 and second port 4, that is the valve member 6 can be controlled to stop in any position from fully closed position 27 to the fully open position 28. This may be achieved in a number of ways, not least of all for example by using an actuator 15 that can be stopped in any position in its range of travel. For example the rotary actuator 15 of FIGS. 17 and 18.

It is to be understood that the valve 1 is omni-directional in the sense that the fluid may flow through the valve 1 in either direction. As a result, it is to be understood that first port 3 can act as either an inlet or outlet and, similarly, second port 4 can act as either an inlet or outlet, depending on the direction of the flow. For clarity throughout the specification, the first port 3 and second port 4 may have been used to provide a flow direction to clearly describe the invention, however the flow direction through the valve 1, including the features within, is not to be constrained to the direction used herein.

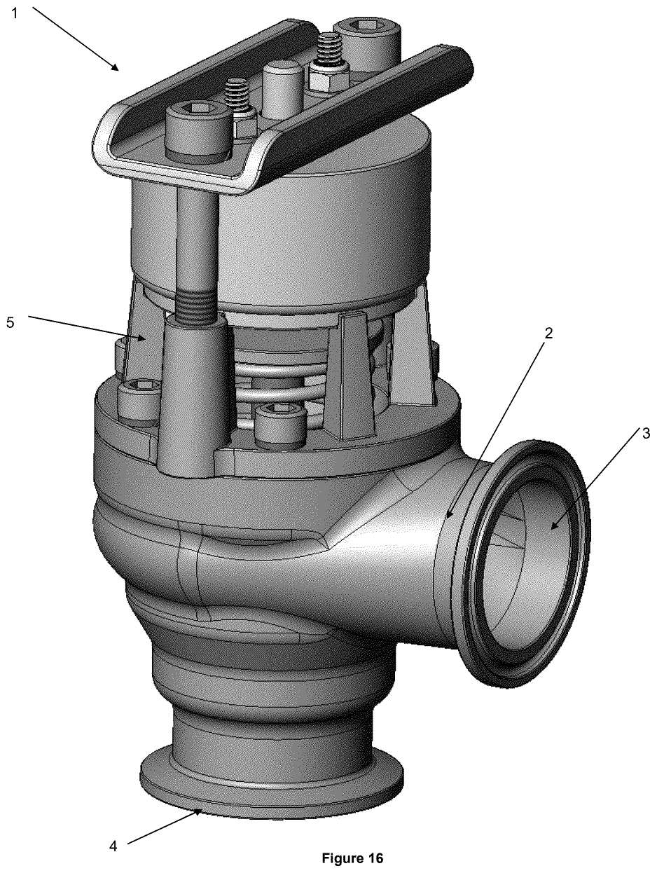

In the version of the valve 1 shown in FIGS. 1 to 15 the valve 1 in inline, that is the first port 3 is in line with the second port 4. The valve body 2 may also be angled such that the first port 3 is angled vertically from the second port 4. The angle of the valve body may vary between 0 degrees, that is, in line as shown, and 180 degrees, that is the outlet faces in the same but opposing direction as the inlet. An example of a ninety degree valve 1 is shown in FIG. 16. The valve 1 shown here is a two-way valve, but is not intended to be limiting and the invention described could also be used for a three or more way valve.

The inlet and outlet may be joined in any conventional way to a fluid conduit, for example a pipe or similar, to carry the fluid to and from the valve. In the examples shown the inlet and outlet are bolted to the conduit using a bolted flange. However, in other forms the valve 1 may be welded in place, use collars or similar.

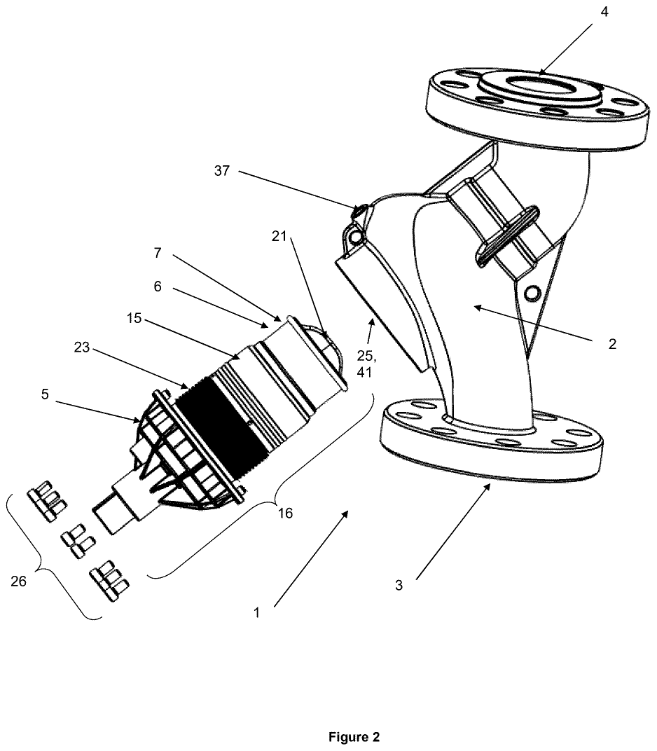

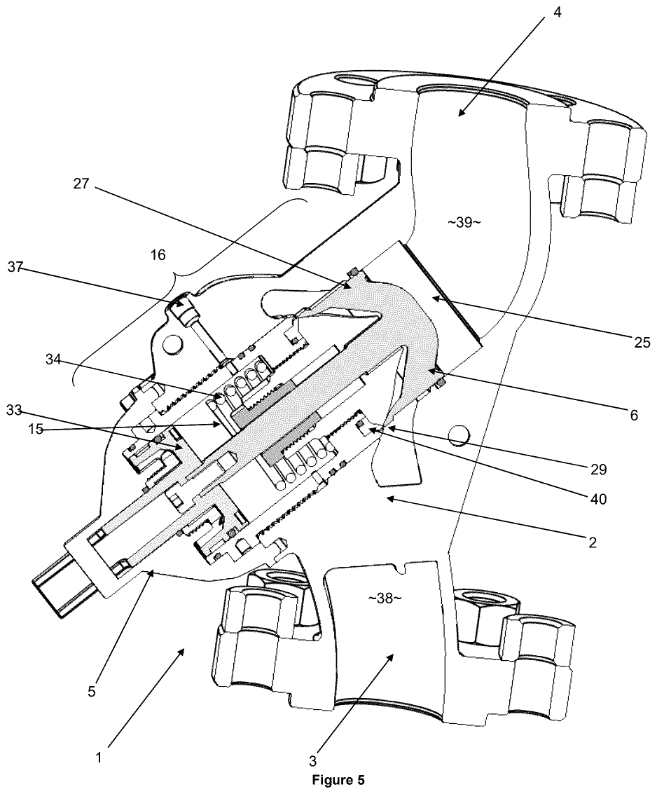

The valve comprises a valve body 2 which has the first port 3 and second port 4 through which the fluid enters and exits, or vice versa, the valve 1, respectively. The valve body 2 has a valve bonnet aperture 41, which leads to the cavity 25 as shown in FIG. 2 and in more detail in FIG. 5. In one variation of the invention the interior of the valve bonnet aperture 41 is threaded to receive a complimentary thread 23 of the actuator (discussed below). The valve 1 has a valve bonnet 5 which in the preferred form is housed substantially within the valve bonnet aperture, and thus the valve body. The valve bonnet 5 is removably engaged with the valve body 2 between the inlet 3 and the outlet 4 and closes off the valve bonnet aperture to define a cavity 25 through which the fluid is controllably passed through.

The valve bonnet 5 is removably engaged within the cavity 25, the retention may be in any way necessary, and in the variation shown, for example in FIG. 2 there are a series of bolts 26, that pass through the bonnet and thread into the body 2.

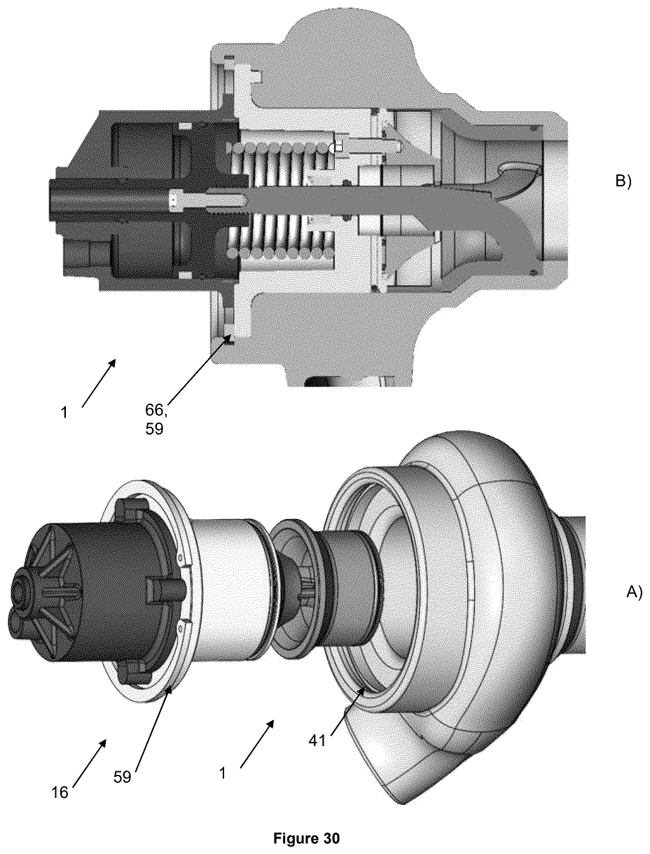

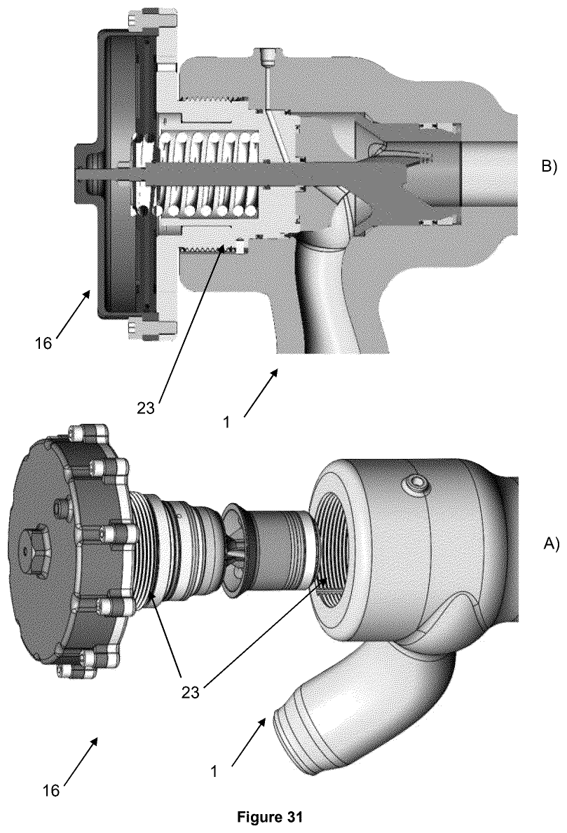

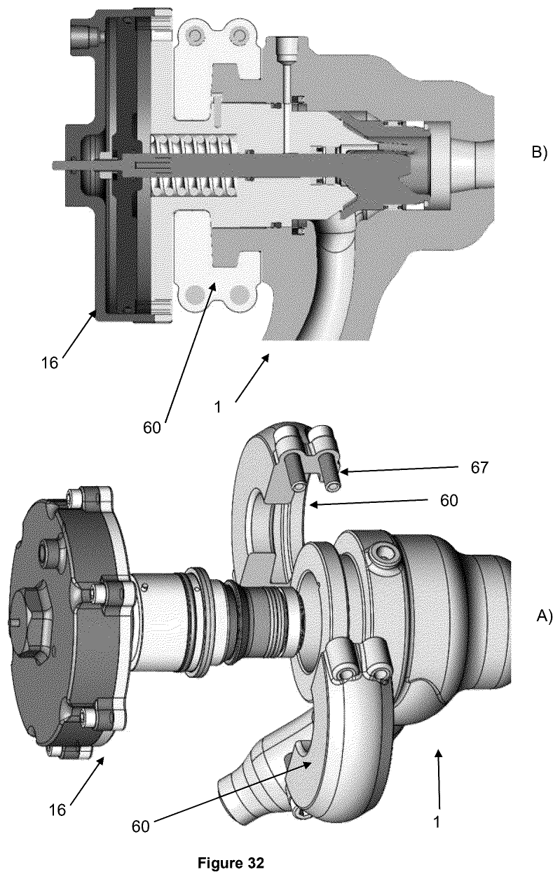

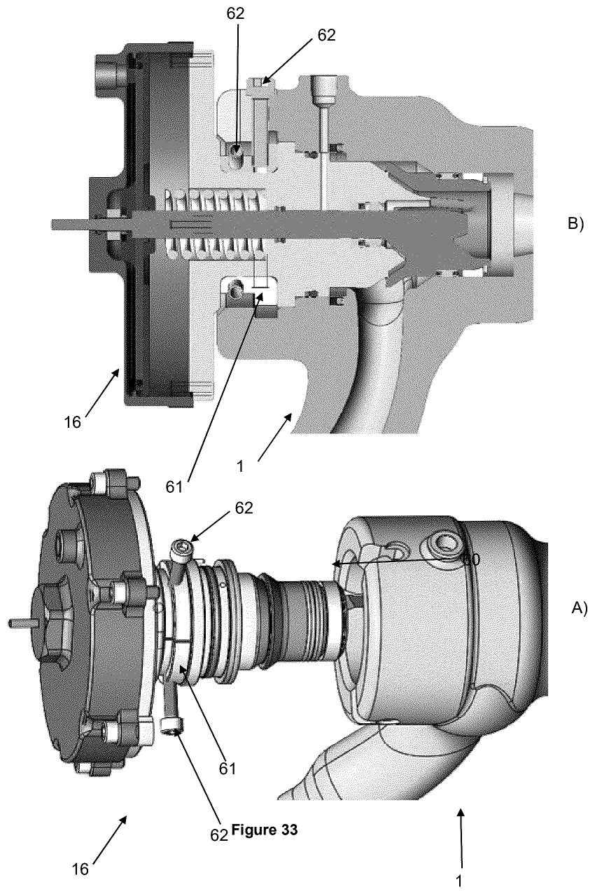

Other methods of attachment are shown in FIGS. 29 to 33. In one method shown in FIGS. 29, 30A and 30B an internal circlip 59 is used. The valve bonnet, unitary assembly 16 is located into the valve bonnet aperture 41 as shown in FIG. 30B. After locating in place the internal circlip 59 is located in place to locate over the valve bonnet 5, and under-engage a groove 66. The interface of one or more of the surface of the circlip, valve bonnet or groove may be tapered to increase the force holding the unitary assembly 16 in place. Another variation is shown in FIGS. 31A and B where the unitary assembly 16 is threaded into place to a mating thread in the valve body and aperture 41. This may be used there the size of at least prt of the actuator as shown is greater than the diameter of the valve, preventing use of a circlip or similar. A further attachment method is shown in FIGS. 32A and B where an external collar 60 is used. Again the unitary assembly is located in place in the aperture 41 and then the collar 60 shown in two pieces here is located to under-engage the valve body 2 and over engage the assembly 16. Collar fasteners 67 on each side (four are used as shown) connect between the collars are used to tighten the collar 60 into place. Again one or more of the surfaces of the collar, assembly or valve body may be tapered to increase the force of the assembly 16 into the valve body as the collar fasteners are tightened. While a two piece collar 60 is shown here, they could also be more than two, and there may be hinges in place of fasteners, or the collar may be flexible and have only tensioning fasteners to tighten its diameter and hold the assembly in place. A further attachment method is shown in FIGS. 33A and B. This uses an internal collar 61, which again is multipiece. The assembly 16 has the internal collar assembled in place about it. The collar 61 has a collar bias 63 in the form of a spring that sits over the collar 61 pieces as shown and contracts them around the assembly 16. The assembly is located in the aperture 41 and rotated until threaded apertures in the collar align with holes in the valve body. Collar fasteners 62 are then passed through the holes to then thread into the collar pieces and expand it. The collar will then under engage the valve body and over engage the assembly 16. Again one or more of the surfaces of the collar, assembly or valve body may be tapered to increase the force of the assembly 16 into the valve body as the collar fasteners 62 are tightened.

The bonnet 5 is located in and attached to the body 2 as described above. Thus, the bolts 26 or other fastening components described above must be removed before the bonnet can be removed from the valve body 2. However, other systems to retain the bonnet 5 to the body 2 may be used, for example bolting only, clamping, threading or other methods or combination known in the art. In the preferred form the sub-assembly of the valve bonnet, actuator and valve member are at an angle to the inlet axis 35 and outlet axis 36 of between 15 degrees and 75 degrees.

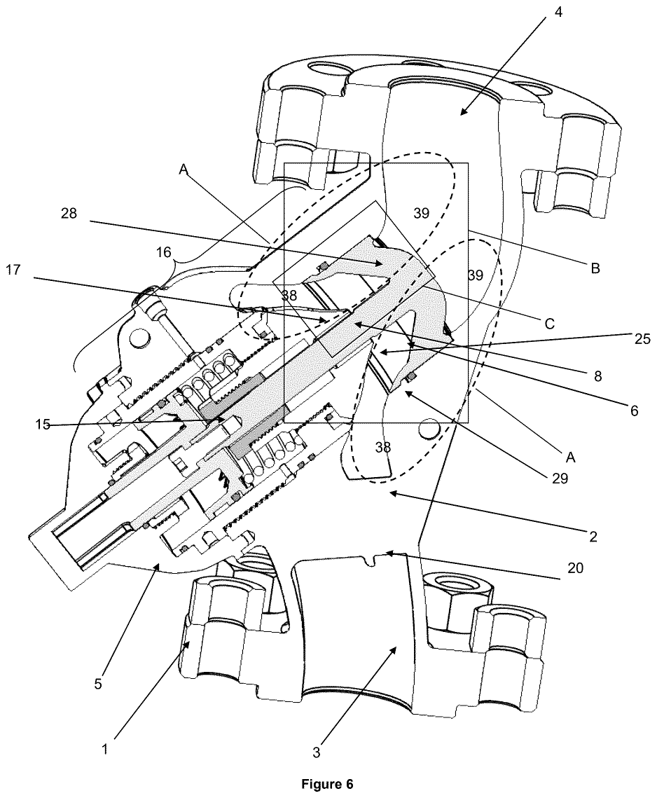

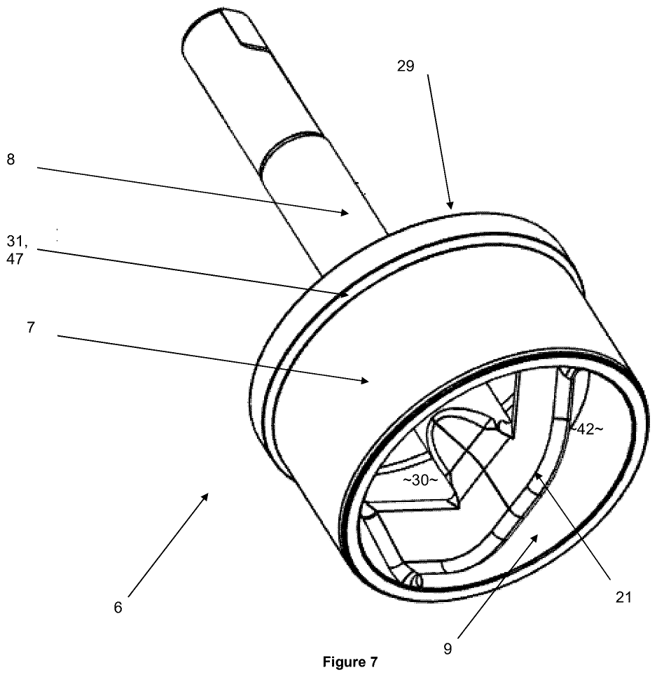

The valve 1 has a valve member 6, shown for example in FIGS. 2, and 5 through 7, which can translate between a closed position 27 as shown in FIG. 5, and an open position 28 as shown in FIG. 6. The valve member 6, shown in detail in FIG. 7 is mounted from a central spindle 8. The central spindle 8 is in sliding and sealing engagement with the valve bonnet 5, via flow conditioner 17 and controlled by the actuator 15. Optionally the spindle 8 may be hollow and allow the, or another, fluid to flow through its interior, into, or towards, the interior diameter. This may allow for mixing or otherwise.

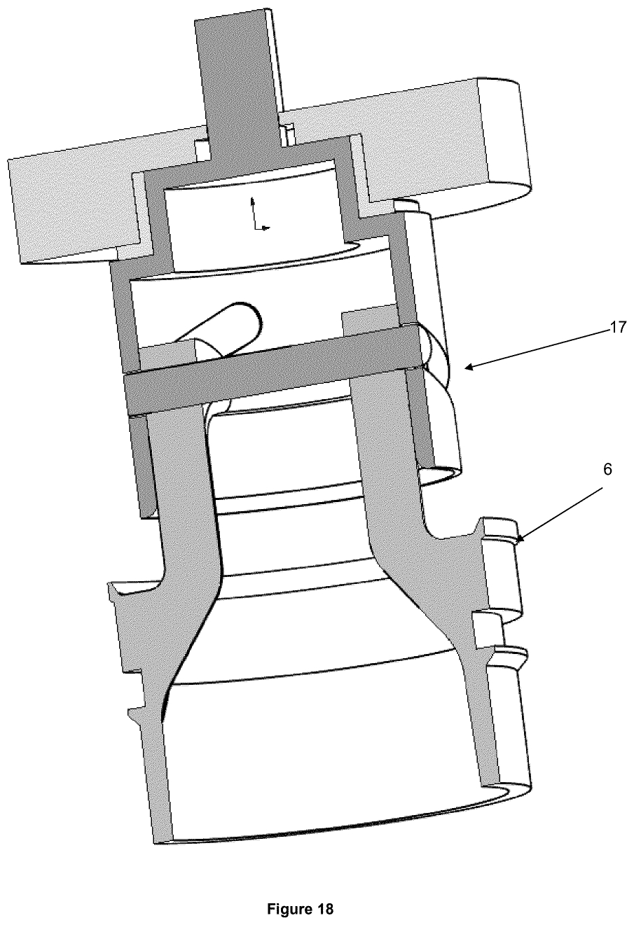

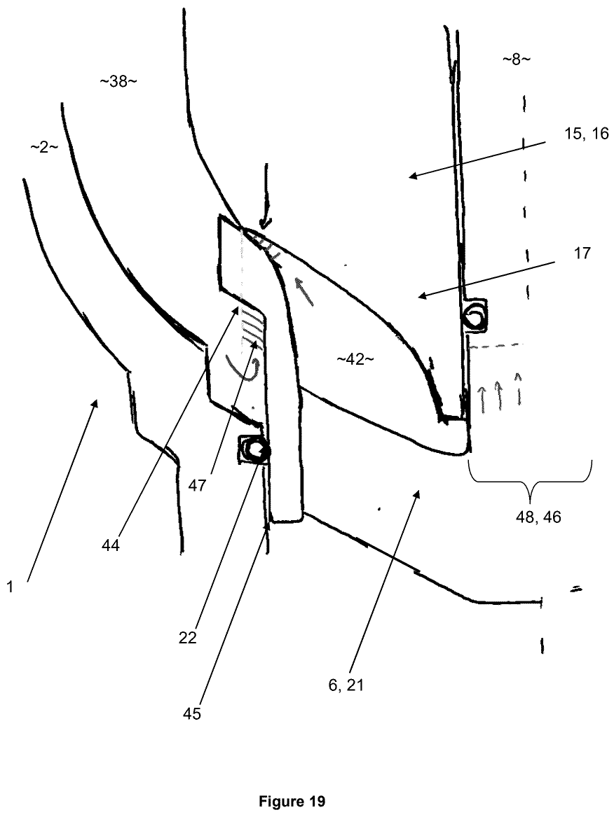

The actuation of the spindle 8 and valve member 6 may be achieved through a number of mechanisms. The actuator may be linear as shown in for example in FIGS. 2, 5 and 6, or may be a rotary actuator as shown in FIG. 18. The example in FIGS. 18 and 19 uses a non-rising stem actuator, and a radial stem seal can be used—for example where there is a rotating element in the actuator, actuatable from outside the wetted valve interior, that acts on the valve member via a cam or screw profile, for example on the spindle. The valve member being linearly guided within the valve body.

The valve member 6 is shown in more detail in FIG. 7. The valve member 6 has an endless skirt 7 supported from the central spindle 8 from one or more vane(s) 21. The vanes in the preferred variation are shaped to produce as little drag on the fluid flow as possible, and may be for example be a low drag profile such as, but not limited to aerofoil or other shape in cross section. The endless skirt 7 defines, at or toward, and preferably at, its uppermost edge a sealing edge or periphery 29. It is this periphery 29, when in the closed position that seals on the flow conditioner 17, actuator, bonnet or parts thereof to seal off the fluid flow, such as shown in FIG. 5.

When the valve member is in the open position as shown in FIG. 6 the fluid can flow over this periphery 29 and through the interior diameter 30 of the endless skirt 7 into the inner chamber 39 and through to the outlet 4. The interior diameter 30 defines at least in part an inner chamber 42 of the valve member 6. Visible in FIG. 6 in areas A is the clear and smooth tangential edge transition from the annular chamber 38 to the valve member 6, over the sealing periphery 29, into the interior of the endless skirt 7, and to the inner chamber 39. It is clear there are no sharp edges or sharp changes in curvature over at least this region, and preferably over the whole flow path from inlet to outlet (or may be reversed if fluid is flowing in the opposite direction), such that the fluid moving through the region sees smooth surfaces and gradual changes. The leading edge (if fluid flow is from bottom to top) of the sealing periphery 29 is contained in a recess of the internal periphery 9 of the cavity 25. Likewise, the trailing edge (again if fluid flow is from bottom to top) of the endless skirt 7 locates into a complimentary recess in the internal periphery 9 as shown in FIG. 6, the shape of these recesses being visible in FIG. 5 when the valve is closed. Thus, the external shapes of the valve member fits into complimentary forms in the internal periphery of the cavity when in the open position, to present the lowest flow obstruction to the fluid, presenting smooth tangential surfaces and continuous curvature from one component to the next. The additional effect of this is that there are no, or very few cavities for liquid or other deposits to pool or build up. This leads to a valve that has reduced maintenance because of less build-up internally, and a more hygienic valve that is easily cleaned in place and flushed.

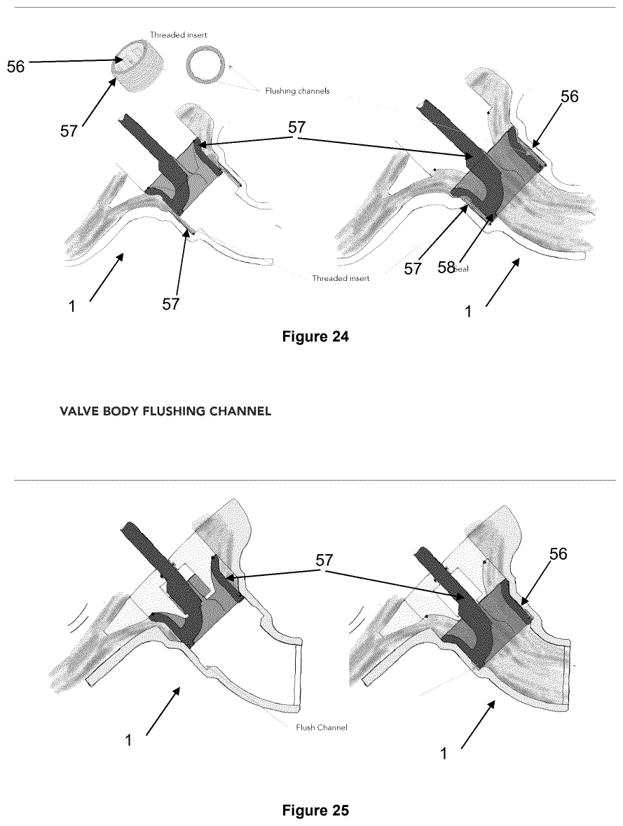

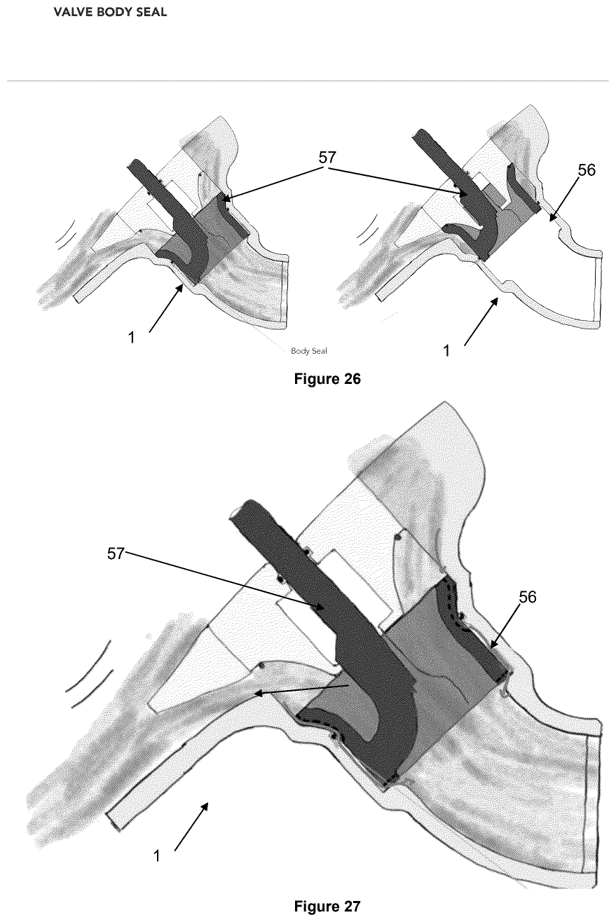

In the situation where Clean In Place (CIP) is necessary either remove particulates or to sterilise all fluid contact area of the valve flushing channels 56 as shown in FIGS. 24 through 28 may be present. These may be provided by a removable insert 57 that is located in place prior to the assembly 16 being inserted into the valve body such as shown in FIG. 24. The insert 57 may be retained by any number of ways, such as, but not limited to being threaded or a push fit. The insert can be removed and installed through the aperture 41. The insert provides one or more flushing channels 56 to allow the fluid, or a CIP fluid to pass through them when the valve member 6 is in the open position and allows for removal of debris, particulates and sanitising. In other forms there is no insert, but a pathway as shown in FIGS. 25 and 26 as a flushing channel is provided between the valve member 6 exterior periphery and the valve body when the valve member is open to allow fluid or CIP fluid to pass through and remove debris and clean such as shown in FIG. 27.

The flow conditioner 17, again visible in area A in FIG. 6 is shaped to present a smooth steady tangential transition for the flow to move over (or from) the diameter of the actuator and bonnet subassembly 16 onto the spindle 8 and through the endless skirt. In one variation the spindle is recessed as shown to provide a lip to lie against the end of the flow conditioner to smooth the flow in that region. The result is the valve member when in the open position presents a tangential edge between any one or more of, the edges of the endless skirt (that is the sealing periphery 29), and/or the edges of the valve bonnet/flow conditioner transition to the spindle. This results in a valve that has a smooth flow through the cavity and valve member.

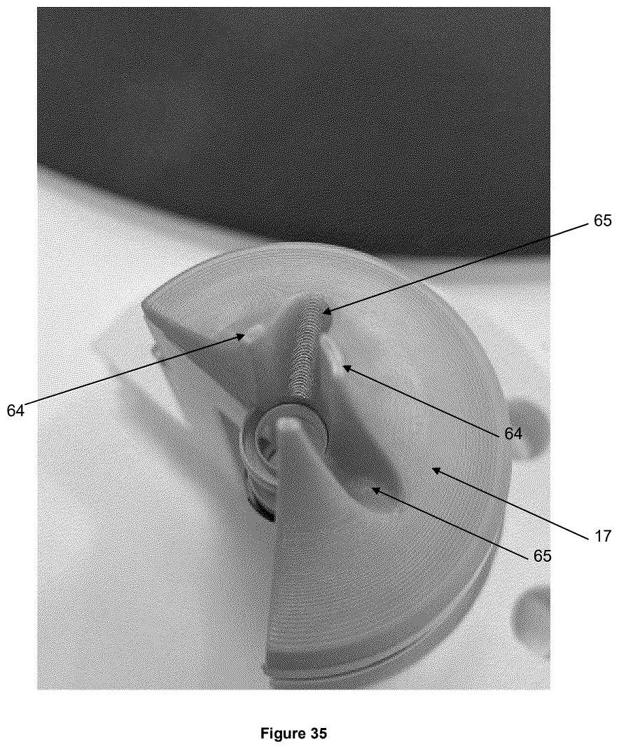

More detail of the flow conditioner 17 is shown in FIG. 35, where the flow conditioner 17 has extensions 64 that pass either side of the vanes 21 of the valve member 6, and form reliefs 65 for the vanes 21. These finger like extensions 64 smooth the fluid flow and keep it as attached as possible when moving from the actuator through the valve member, thus aiding in the efficiency of the valve.

In the preferred variation no part of the annular cavity resides within the diameter of a seal between the valve body and valve member, this allows for easy withdrawal of the subassembly 16 from the cavity as one unit with no operating parts left behind.

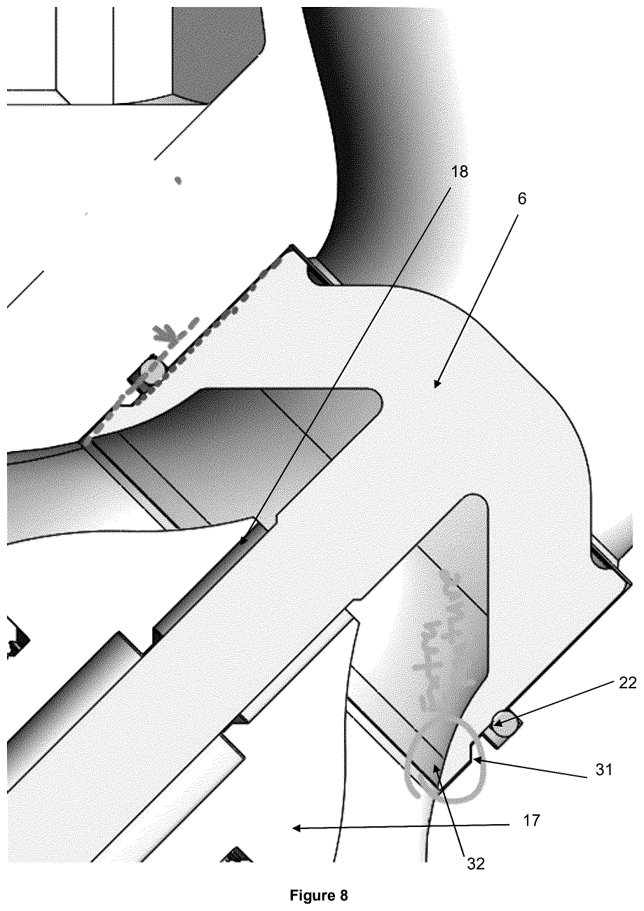

The exterior surface 31 of the endless skirt is in a sliding and sealing engagement with an interior of the cavity, this will be described in more detail below. The exterior surface 31 is parallel to the movement of the spindle to present and allow a smooth action. In the preferred form this seal 22, shown in FIG. 8 for example, is an O ring, though any form of suitable seal may perform this function. The endless skirt 7 presents this exterior sealing surface to engage and seal to a cavity interior presenting surface of the valve bonnet when in the closed position as described. While the endless skirt is shown as circular, any form of constant cross section that can slide and seal throughout that sliding with the cavity interior may be used.

The valve bonnet 5 contains an actuator 15 for the spindle 8 to at least open and close the valve 1 by moving the valve member via its spindle. The actuator 15 may be actuated by any one or more of the following: gas, fluid, magnetic, mechanical, or electrical means. The actuator 15 is held or contained within the valve body 2 by the valve bonnet 5 as earlier described and extends at least in part into the cavity. The actuator 15 may be formed integrally with the valve bonnet 5 and/or the valve member 6. The actuator 15, valve bonnet 5, and valve member 6, may be a unitary subassembly 16 that is removable from the valve body 2 as an assembly. Importantly this allows easy maintenance, inspection and repair of these components. Removal of this sub-assembly 16 allows access into the interior of the valve body, and the sub-assembly if necessary can easily be replaced, and later repaired as needed. In addition such easy removal allows access to the flow conditioner and seal of the spindle from the flow or wetted side of the valve. This removes the need for traditional stuffing box systems that are normally accessed from above and external of the valve member in prior art systems. Access from the interior or wetted side by removal of the sub-assembly, easy replacement in situ with a replacement sub-assembly, and servicing of the removed subassembly at a later point, for example in a workshop allows for better sealing and servicing and a more sophisticated energised, whether by pressure fluid, or static seal pressure system can be used as shown to seal the spindle to the actuator, flow conditioner. Simple removal of the valve member 6 and then the flow conditioner allows access to the spindle seal 19 for maintenance or replacement.

A further advantage of this removable subassembly is the ability to manufacture a valve body 2, into which a range of subassemblies 16 can be installed depending on the end use of the valve, for example operating pressure and fluid type to be controlled. Thus a wide range of valve applications can be achieve from the one valve body and choosing the subassembly to fit the end use. Also, a valve 1 that has been installed can also be changed in this way when in situ also if necessary.

The removability of the unitary subassembly 16 can provide the advantage of providing an ease of cleaning if necessary of the unitary subassembly, its components and the valve body 2. Further, the removability allows for simple replacement, repair, or other maintenance of the components of the unitary subassembly 16.

The valve 1 may also be biased to a certain position by the pressure of the fluid, in addition to actuator.

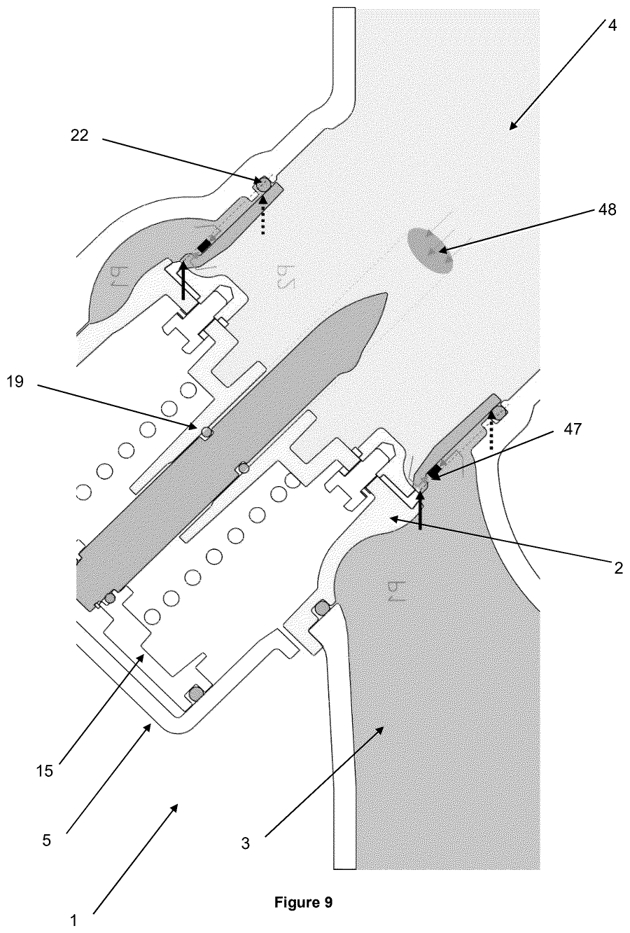

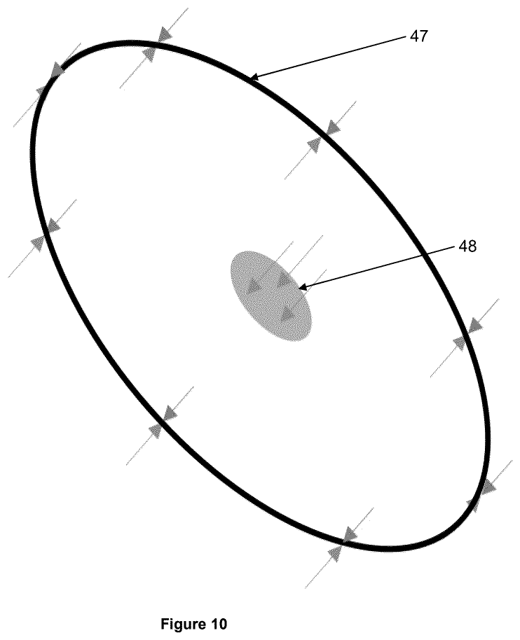

The pressure of the fluid acts on the valve member 6 and its surfaces shown in FIG. 8. One simplified way to consider it is via the overall net balance of pressure surfaces that experience pressure from the fluid and hence develop a force to open or close the valve 6. An overall upstream (in this configuration) facing surface 32 of the valve member 6 can experience pressure to bias it open, or an overall down stream (in this configuration) facing surface 31 of the valve member 6 can bias it closed, or there is an overall balance between the upstream and downstream surfaces of the valve member 6 that is it neutrally biased by the pressure of the fluid. If the flow was in reverse then then these surfaces would see the opposite fluid flow and pressure and bias the valve in the opposite way. An overall down stream (in this configuration) 31 facing surface is shown in FIG. 8 which acts to bias the valve element 6 to a closed position. This pressure differential is shown in more detail in FIG. 9 and their resultant overall forces in FIG. 10.

As shown in FIG. 8 through 10, a pressure difference from the down stream side (in this fluid flow configuration) of the valve member 6 can act to seal the valve 1. The valve member 6 is biased close via the net annular pressure area 31 defined between the valve body 2 and at least one seal located on the endless skirt 7 of the valve member 6 (shown as P1). The spindle 8 has a pressure area also (shown as P2) and this will add to the overall force on the valve member 6 such that the valve will be held closed. As such, the valve member 6 will remain in a closed position in the absence of action by the actuator. In this configuration there is no pressure state in which the valve will open by itself, it must be actuated to open. This is a fail safe feature of the valve in that should the actuator or signal/supply to it fail the valve will close.

The pressure area defined by the diameter or sealing perimeter of the valve stem is larger than to the pressure area defined by the difference between the face sealing diameter and the seal between the body and endless skirt to ensure pressure assisted closing when the larger pressure is on either side of the valve.

The overall upstream surface may be provided by an upstream facing surface on an outside diameter of the endless member as shown in FIGS. 7 and 8.

The overall downstream surface may be provided by a downstream facing surface on an outside diameter of the endless member.

Using the ‘upstream/downstream facing’ language-making the valve member pressure bias the upstream facing pressure area, and the spindle seal the downstream facing pressure area. However, if flow direction is changed, and the outlet is now the inlet, and the inlet is now the outlet, then if follows that up stream and down stream, and their effects are reversed also.

In the preferred variation the valve 1 is pressure biased closed. This is beneficial due to the safety benefit of the valve naturally wanting to close unless acted on by the actuator. Technically it is ‘unbalanced’ pressure-wise but it is more accurate to say it ‘is balanced, but with a tuned pressure bias closed’.

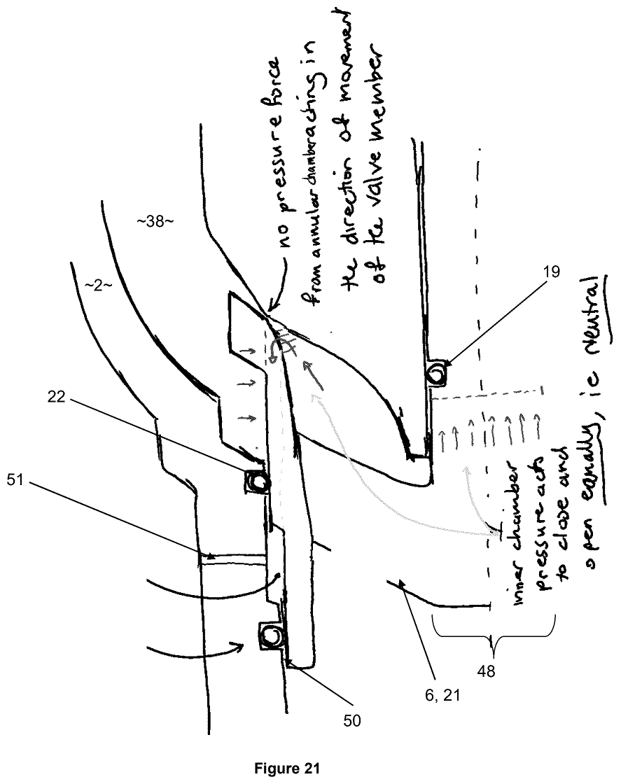

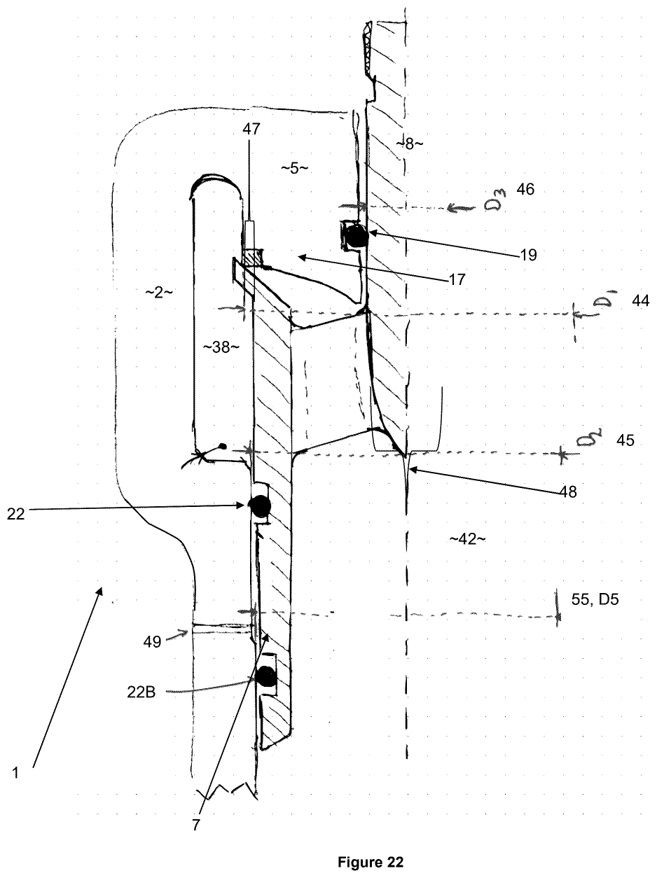

How this is achieved is further set out schematically in FIG. 22 being a close up vertical cross section of one half of the valve actuator axis, with variations of it shown in FIGS. 19 through 21 and is better described below. Referring to FIG. 22 the first sealing diameter or periphery D1 44 is defined by the sealing diameter or periphery of the endless skirt 7 when sealed against the valve bonnet 5 (or extension thereof, such as the flow conditioner 17.

The second sealing diameter or periphery 45 D2 is the periphery defined between the valve body 2 and external periphery of the valve skirt 7.

When D1 is greater than D2, as shown in FIGS. 22 and 19 this creates a first pressure area 47 (previously referred to as upstream facing pressure area), which is acted upon by the fluid pressure from the first port 2 and inlet volume 38 (annular chamber) to close the valve member 6 (and hence the valve). When there is higher pressure in the annular chamber 38 than in the inner chamber 42, there is a closing force generated on the upstream facing pressure area.

The spindle seal 19 defines a sealing periphery or diameter D3 and defines a second pressure area 48 which is acted upon by the inner chamber 42 pressure. This creates a force in the closing direction for the valve member 6.

If the inner chamber 42 pressure drops below atmospheric pressure there can be a net opening force generated, however the valve seating spring/actuator bias 34 or other bias is selected to accommodate/overwhelm this pressure force to ensure valve closure is maintained, if opening under vacuum conditions is seen as detrimental.

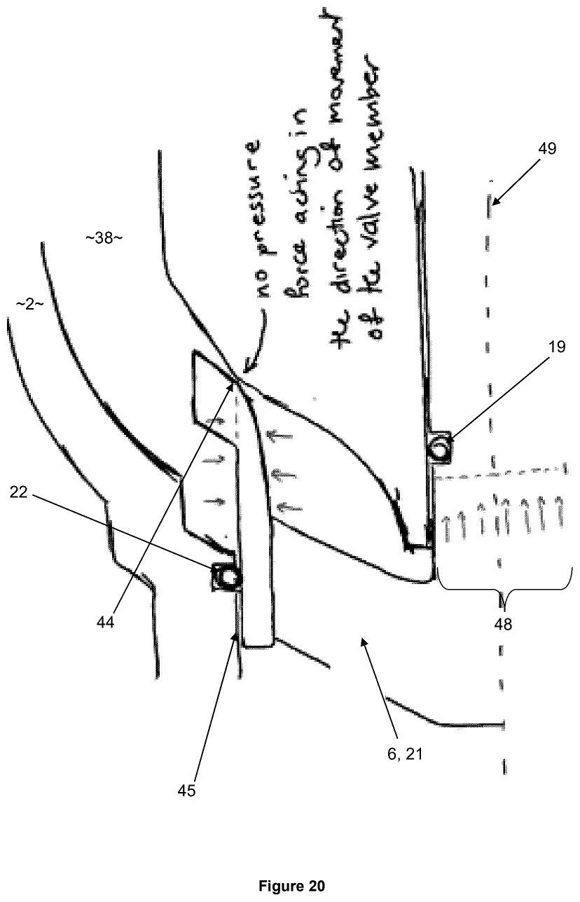

An alternative configuration of the invention is where there is no net first pressure area, that is D1 and D2 are equal as shown in FIG. 20, the only net pressure is that supplied by D3 defining the second pressure area 48. The annular chamber 38 can be fully balanced as to enable easier opening, which can be referred to as neutral annular chamber balancing.

The spindle seal diameter D3 forming the second pressure area 48 (downstream facing pressure area) is still acted upon by the inner chamber 42 pressure, and always in the closing direction when there is positive pressure present. If the inner chamber pressure drops below atmospheric pressure there can be a net opening force generated, however the valve seating spring/other bias would be selected to accommodate/overwhelm this pressure force to ensure valve closure is maintained, if opening under vacuum conditions is seen as detrimental.

A further configuration of the present invention is what could be termed “fully neutrally balanced”. The schematic for this is shown in FIG. 21. This is achieved by the sealing diameters between the body and valve member D2, and the valve member and the bonnet D1, to form a first pressure area 47 equal to but opposite to second pressure are 48 defined by the third sealing diameter or perimeter D3 of the spindle. This results in the valve member neither opening or closing under operating conditions and requires the actuator to move it.

The spindle seal pressure area contributes to the downstream facing pressure area as in the Neutral annular chamber balancing option, but an additional seal is added (D4 in FIG. 22). This, when present, adds an annular pressure area which acts in the opposite direction, resulting in NO net downstream facing pressure area. With no net upstream or downstream facing pressure areas, the valve is fully balanced.

The term here overall is taken to mean a net difference, either facing upstream or downstream.

A further feature of the present invention in the preferred form is the second pressure area 48 is larger, but not more than 20% larger, than the first pressure area 47, paired with a closing or actuator bias that is of sufficient force to hold the valve closed against a vacuum condition in the inner chamber 42.

This is useful as creating a balanced valve to lower force is beneficial and allows for a valve that is easier or harder to open by having the inlet pressure act on a pressure bias. In addition, this ensures that there is always a closing pressure bias on the valve no matter what the pressures in the two chambers are except in the case of vacuum as described, but this then requires a sufficient closing bias to do so. This allows those benefits whiles using the pressure area offsets as a safety feature.

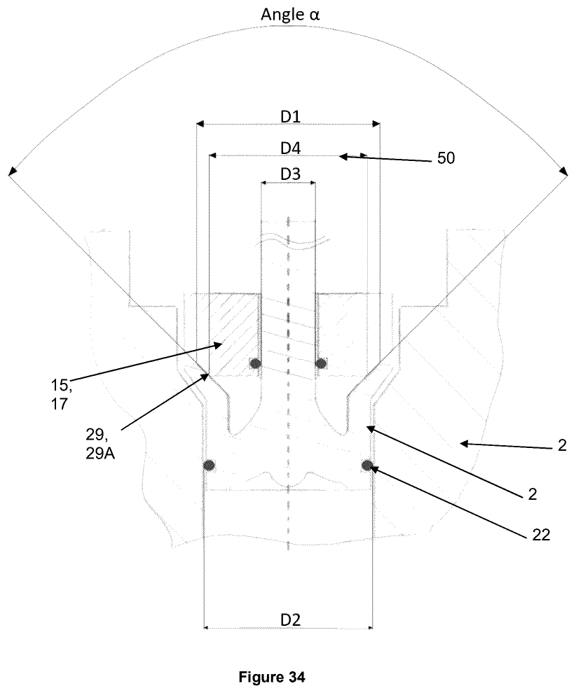

The closing pressure at the sealing periphery 29 between the endless skirt 7 of the valve member 6 and the sealing surface of the valve bonnet or actuator, in this case the sealing surface is on the flow conditioner 17 can be varied, especially when that sealing interface between the valve member and flow conditioner is considered as a sealing surface 29A, rather than as a line or periphery, as shown in FIG. 34.

In FIG. 34 there is a forth sealing diameter or periphery 50, D4 which with the first sealing diameter or periphery 44, D1 defines the sealing periphery surface 29A. The angle of this surface Alpha a is the angle this surface 29A presents to the longitudinal actuator axis 49. The total area of surface 29A for a given pressure of the fluid being controlled, and the material hardness of the endless skirt 7 and flow conditioner 17 that engage to form the surface 29A (or other components that form that interface surface 29A) can be varied to allow either, or both, on sealing, to undergo elastic, transient, or plastic deformation. Transient deformation is when any highs present at the interface surface 29A are plastically deformed.

The actuator 15 in one variation may have a piston 33 on which upper surface a pressurised control fluid may act. The piston in turn is connected to the spindle 8. Control fluid, e.g. air or liquid, will act on the piston 33 and against a bias 34, for example a return spring. When the pressure acting on the piston 33 can overcome the bias 34 and any net pressure acting on the valve element, the control pressure will move the valve element 6 from the closed position to the open position. When it is desired to close the valve the control fluid pressure is reduced and the bias 34 and any net pressure on the valve element from the fluid it is controlling will move the valve element to the closed position. This is for a biased closed valve. The surface the control fluid acts on, and the direction of the bias may be swapped to have a biased open valve. Other forms of actuator may also be used. One such version is shown in FIGS. 18 and 19 which uses a rotary action inside the actuator to move the valve member 6.

There is a flow conditioner 17 shown in close up in FIG. 35 as described which can provide the tangential edge between the valve bonnet 5 or actuator 15 and the spindle 8. The flow conditioner 17 can be selected depending on the fluid type. As an example, the selection of flow conditioner 17 can depend on at least the viscosity, phase, inclusions, of the fluid. Further, the selection of the flow conditioner 17 can also be for the desired purpose of the flow conditioner 17 for example to keep the flow laminar, keep the flow turbulent, remove or add cavitation, improve mixing of the fluid, or similar. As such, the flow conditioner 17 may be altered to vary the effect the flow condition has on the flow. The flow conditioner 17 has an aperture 18 through which the spindle 8 extends into the actuator and bonnet, and out of the actuator and bonnet to the vanes 21 and endless skirt 7. The aperture 18 also holds, in the preferred form, the stem seal 19 which can slidingly seal the spindle. The stem seal 19 may be positioned near the actuator 15, to provide a more compact design. The stem seal may be actively energised by the pressure of the fluid passing through the valve, the control fluid, or may be statically energised.

In an open position, an opening is defined between the endless skirt 7 and the valve bonnet 5 such that the fluid can flow through the opening and through the interior diameter of the endless skirt 7, as described. Further, the open position provides a tangential edge 11 between an uppermost stream edge 12 of the endless skirt 7, a downmost stream edge 13 of the endless skirt 7, and/or a downstream edge of the valve bonnet 14 transition to the central spindle 8. The tangential edge is provided as a primarily smooth surface such that the flow through the cavity of the valve 1, in particular the valve member 6, is smooth. The primarily smooth surface is advantageous as may provide increased efficiency of the valve 1 due to a reduction of friction, turbulence, or other deterrents. The primarily smooth surface also provides the advantage of less protrusions within the flow path and therefore a reduction in the potential disadvantages of these protrusions which may include build-up of material from the flow, additional cleaning requirements, dead zones of flow, or otherwise.

Likewise, the flow conditioner 17 may aid in in directing the fluid flow through the endless skirt 7 and keeps the flow attached. The flow path through the valve body 2 from inlet 3 to outlet 4 may be a constant cross section.

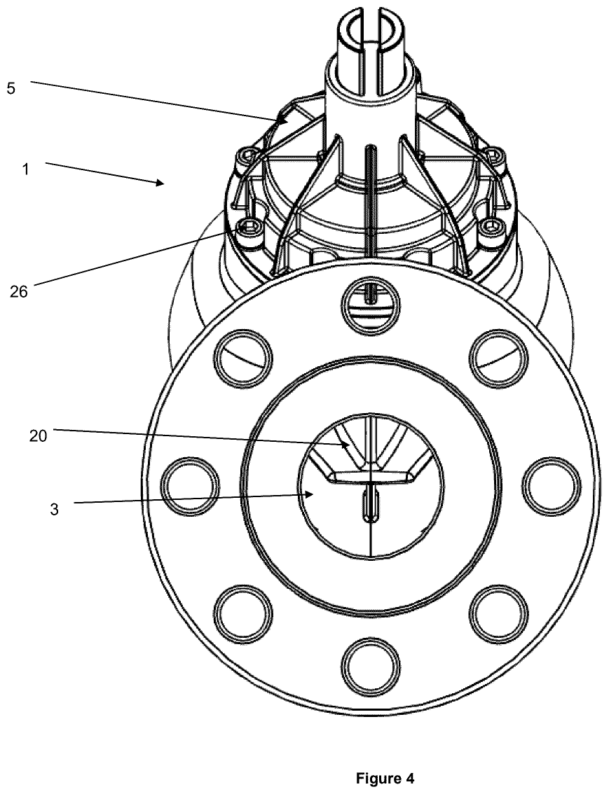

There is a flow splitter 20 downstream from the inlet 3 prior to the valve member, in the annular chamber 38 as shown in FIGS. 6 and 4. The flow splitter 20 may be capable of splitting the flow of the incoming fluid vertically, horizontally, or both. The flow splitter 20 may assist with diverting the flow to improve the flow through the endless skirt 7.

Whilst the valve has been described as flowing from the inlet to outlet as described it may also control flow of fluid in the other direction, such that what was the outlet is now the inlet, and what was the inlet is now the outlet.

A clear additional advantage of the present invention is the location of the majority, or all of the actuator within the valve body and only a comparatively valve bonnet extending therefrom. This provide a compact and versatile valve 1.

The invention provides for valves that have flexible pressure balancing options, the actuation force requirements of the valve are decoupled from the operating pressure and flow capacity, and the chamber layout options allow high flow capacity for the size.

Further, only part of the valve 1 needs to be removed to be serviced—the unitary assembly 16, and such “through bonnet” servicing is often faster than full valve disassembly from its connected pipework—meaning that bench servicing time can be shorter and therefore cheaper. Servicing and repairing this way leaves the valve body 2 connected to the pipe work, the valve bonnet is removed as a unitary assembly 16, a new or working unitary assembly 16 can then be installed back into the still installed valve body 2 and the valve 1 can then be re-commissioned without lengthy delay. No re-sealing or reconnecting of the valve body 2 is needed. The removed unitary assembly 16 can then be bench service and put back into stock as necessary.

The architecture of the present valve when viewed for example in FIG. 5 is one that has no through wall thickness surfaces that are in contact with the fluid on both sides. Valve body 2 is defined by a wall as shown that has external surfaces defining the exterior 68 of the valve, and interior surfaces that define the duct or cavity within the valve body. There are no intermediate walls in contact with the fluid on both their sides internally of the valve body. The external surfaces are directly opposed to a mating internal surface through the thickness of the wall. Unlike prior art valve, there are no through wall opposing internal surfaces of the valve body that are in contact with the controlled fluid under pressure on both sides, there is only a continuous internal surface, no surface that doubles back on itself so it is in contact with the controlled fluid on both sides. This leads to a valve that can be more easily manufactured and the fluid when moving through the valve sees a continuous smooth path. The valve body, in so far as surfaces the fluid can contact is only defined by the outer wall of the valve body.

The foregoing description of the invention includes preferred forms thereof. Modifications may be made thereto without departing from the scope of the invention.

1. A valve to control flow of a fluid under pressure, comprising,
a valve body with a first port, and a second port, to, in part, define a duct therebetween, to duct the flow of the fluid between the first port and the second port,
a valve bonnet removably engaged to the valve body between the first port and the second port, to further define the duct,
a valve member having an endless skirt supported by a central spindle within the duct from the valve bonnet, the endless skirt having an outer periphery, which the valve body defines an annular chamber about, and the endless skirt having an inner periphery which defines an inner chamber, the valve member having a closed position to prevent flow of fluid, and an open position to allow flow of fluid,
the endless skirt, when in the closed position, sealing against the valve bonnet at a first sealing diameter, the endless skirt in sliding and sealing engagement at, and between, the open position and the closed position, with an interior periphery of the annular chamber at a second sealing diameter, the first sealing diameter greater than the second sealing diameter, a first pressure area defined between the first sealing diameter and the second sealing diameter, the first pressure area on receipt of fluid under pressure providing a bias toward the closed position,
the endless skirt when in the open position defining an opening between the valve bonnet and endless skirt to allow fluid flow between the first port, via the opening and an interior diameter of the endless skirt, and the second port, the central spindle in sliding and sealing engagement with the valve bonnet at a third sealing diameter, less than the second sealing diameter, the third sealing diameter defining a second pressure area, the second pressure area on receipt of fluid under pressure providing a bias toward the closed position,
such that a valve is provided that is biased towards the closed position when in either the open position or closed position.

2. The valve as claimed in claim 1, wherein the second pressure area is larger than the first pressure area.

3. The valve as claimed in claim 1, wherein the valve body has a valve bonnet aperture to which the valve bonnet is operatively connected to seal the duct, other than the first port and second port.

4. The valve as claimed in claim 1, wherein the valve bonnet contains or holds an actuator for the central spindle to move the valve member between the open position and closed position.

5. (canceled)

6. The valve as claimed in claim 4, wherein the actuator, or part thereof, is held or contained within the valve body by the valve bonnet and extends at least in part into the duct.

7. (canceled)

8. The valve as claimed in claim 4 wherein the actuator, valve bonnet and valve member are a unitary subassembly that is removable from the valve body.

9. The valve as claimed in claim 1 wherein the valve member and sealing elements alone separate the inlet and outlet volumes.

10. The valve as claimed in claim 4, wherein the endless skirt extends in an axis parallel to a main axis of the central spindle and actuator.

11. The valve as claimed in claim 1, wherein the endless skirt is of constant cross section, at least on that part in sliding and sealing engagement with the interior periphery of the cavity.

12. The valve as claimed in claim 1, wherein the valve is biased closed by the pressure of the fluid it is controlling.

13. The valve as claimed in claim 1, wherein there is a spring which biases the valve closed when no pressure is present.

14. The valve as claimed in claim 13, wherein the spring force is significantly less than the resultant forces of the pressure areas and design pressures of the valve.

15. The valve as claimed in claim 13, wherein the spring provides higher pre-load force than the force which would act to open the valve from the presence of vacuum within the valve, and atmospheric pressure acting outside the valve.

16.-47. (canceled)

48. The valve as claimed in claim 1, wherein the endless skirt is supported from the central spindle by at least one vane.

49. (canceled)

50. (canceled)

51. A method of providing a valve to control flow of a fluid under pressure, comprising,
providing a valve body with a first port, and a second port, to, in part, define a duct therebetween, to duct the flow of the fluid between the first port and the second port,
providing a valve bonnet removably engaged to the valve body between the first port and the second port, to further define the duct,
providing a valve member having an endless skirt supported by a central spindle within the duct from the valve bonnet, the endless skirt having an outer periphery, which the valve body defines an annular chamber about, and the endless skirt having an inner periphery which defines an inner chamber, the valve member having a closed position to prevent flow of fluid, and an open position to allow flow of fluid,
configuring the endless skirt, when in the closed position, to seal against the valve bonnet at a first sealing diameter, the endless skirt in sliding and sealing engagement at, and between, the open position and the closed position, with an interior periphery of the annular chamber at a second sealing diameter, the first sealing diameter greater than the second sealing diameter, a first pressure area defined between the first sealing diameter and the second sealing diameter, the first pressure area on receipt of fluid under pressure providing a bias toward the closed position,
the endless skirt when in the open position defining an opening between the valve bonnet and endless skirt to allow fluid flow between the first port, via the opening and an interior diameter of the endless skirt, and the second port, the central spindle in sliding and sealing engagement with the valve bonnet at a third sealing diameter, less than the second sealing diameter, the third sealing diameter defining a second pressure area, the second pressure area on receipt of fluid under pressure providing a bias toward the closed position, such that a valve is provided that is biased towards the closed position when in either the open position or closed position.

52. (canceled)

53. The method as claimed in claim 51 wherein the valve bonnet contains or holds an actuator for the spindle to move the valve member between the open position and closed position.

54. (canceled)

55. The method as claimed in claim 53, wherein the actuator, or part thereof, is held or contained within the valve body by the valve bonnet and extends at least in part into the cavity.

56. (canceled)

57. The method as claimed in claim 53, wherein the actuator, valve bonnet and valve member are a unitary subassembly that is removable from the valve body.

58. (canceled)

59. (canceled)

60. The method as claimed in claim 51, wherein, the valve member and sealing elements alone separate the inlet and outlet volumes.

61-81. (canceled)

82. The method as claimed in claim 51, wherein the valve is biased closed by the pressure of the fluid it is controlling.

83.-90. (canceled)
